(19) United States
(12) Patent Application Publication
(10) Pub. No.: US 2026/0370439 A1
(43) Pub. Date: Nov. 19, 2026

(54) USER EQUIPMENTS, BASE STATIONS, AND METHODS

(71) Applicant: SHARP KABUSHIKI KAISHA, Sakai City, Osaka (JP)

(72) Inventors: LIQING LIU, Sakai City, Osaka (JP); DAIICHIRO NAKASHIMA, Sakai City, Osaka (JP); WATARU OUCHI, Sakai City, Osaka (JP); SHOICHI SUZUKI, Sakai City, Osaka (JP); Ryunosuke SAKAMOTO, Sakai City, Osaka (JP)

(21) Appl. No.: 19/142,736

(22) PCT Filed: Oct. 20, 2023
(86) PCT No.: PCT/JP2023/038801

§ 371 Date: Jun. 24, 2025

(30) Foreign Application Priority Data
Dec. 27, 2022 (JP) 2022-209457

(51) Int. Cl. H04L 5/14; H04L 5/00; H04W 72/231

(52) U.S. Cl. CPC H04L 5/14; H04L 5/0094; H04W 72/231

(57) ABSTRACT

A method by a user equipment (UE) is described. The method includes receiving, from a base station, a cell-specific TDD UL/DL configuration; using a SCS configuration provided in the cell-specific TDD UL/DL configuration for setting slot format per slot over a number of slots, wherein each symbol with the used SCS configuration is indicated as downlink symbol, flexible symbol, or uplink symbol by the cell-specific TDD UL/DL configuration; and using the SCS configuration to determine a time offset and/or a frequency offset for an UL transmission region wherein the UL transmission region is configured in symbols indicated as downlink symbol, the time offset is a symbol level offset from a starting symbol of the number of slots to a starting symbol of the UL transmission region, and the frequency offset is an RB level offset from a first common resource RB to a starting RB of the UL transmission region.

### TECHNICAL FIELD

The present disclosure relates to a user equipment, a base station, and a method.

### BACKGROUND ART

At present, as a radio access system and a radio network technology aimed for the fifth generation cellular system, technical investigation and standard development are being conducted, as extended standards of Long Term Evolution (LTE), on LTE-Advanced Pro (LTE-A Pro) and New Radio technology (NR) in The Third Generation Partnership Project (3GPP).

In the fifth generation cellular system, three services of enhanced Mobile BroadBand (eMBB) to achieve high-speed and large-volume transmission, Ultra-Reliable and Low Latency Communication (URLLC) to achieve low-latency and high-reliability communication, and massive Machine Type Communication (mMTC) to allow connection of a large number of machine type devices such as Internet of Things (IoT) have been demanded as assumed scenarios.

For example, wireless communication devices may communicate with one or more devices for multiple service types. In a TDD carrier, time domain resource is split between downlink, flexible and uplink. A limited uplink transmission duration results in the reduced coverage. To configure a UL transmission region in downlink or flexible symbols is under discussion. As illustrated by this discussion, systems and methods according to the present invention, supporting how to determine subcarrier spacing configuration and time-frequency resource for the UL transmission region, may improve the communication flexibility and efficiency and could be beneficial.

### BRIEF DESCRIPTION OF THE DRAWINGS

FIG. 1 is a block diagram illustrating one configuration of one or more base stations and one or more user equipments (UEs) in which systems and methods for how to determine SCS configuration for an UL transmission region may be implemented;

FIG. 2 is a diagram illustrating one example 200 of a resource grid;

FIG. 3 is a diagram illustrating one example 300 of common resource block grid, carrier configuration and BWP configuration by a UE 102 and a base station 160;

FIG. 4 is a diagram illustrating one 400 example of CORESET configuration in a BWP by a UE 102 and a base station 160;

FIG. 5 is a diagram illustrating one example 500 of cell specific TDD UL/DL configuration;

FIG. 6 is a diagram illustrating one example 600 of a slot format table;

FIG. 7 is a diagram illustrating one implementation of a method 700 how to determine subcarrier spacing and time-frequency resources for an UL transmission region by a UE 102 and a base station 160;

FIG. 8 illustrates various components that may be utilized in a UE;

FIG. 9 illustrates various components that may be utilized in a base station;

### DESCRIPTION OF EMBODIMENTS

A communication method by a user equipment (UE) is described. The method includes receiving, from a base station, a cell-specific TDD UL/DL configuration; using a SCS configuration provided in the cell-specific TDD, UL/DL configuration for setting slot format per slot over a number of slots, wherein each symbol with the used SCS configuration is indicated as downlink symbol, flexible symbol, or uplink symbol by the cell-specific TDD UL/DL configuration; and using the SCS configuration to determine a time offset and/or a frequency offset for an UL transmission region wherein the UL transmission region is configured in symbols indicated as downlink symbol, the time offset is a symbol level offset from a starting symbol of the number of slots to a starting symbol of the UL transmission region, and the frequency offset is an RB level offset from a first common resource RB to a starting RB of the UL transmission region.

A communication method by a base station is described. The method includes transmitting, to a user equipment (UE), a cell-specific TDD UL/DL configuration; using a SCS configuration provided in the cell-specific TDD UL/DL configuration for setting slot format per slot over a number of slots, wherein each symbol with the used SCS configuration is indicated as downlink symbol, flexible symbol, or uplink symbol by the cell-specific TDD UL/DL configuration; and using the SCS configuration to determine a time offset and/or a frequency offset for an UL transmission region wherein the UL transmission region is configured in symbols indicated as downlink symbol, the time offset is a symbol level offset from a starting symbol of the number of slots to a starting symbol of the UL transmission region, and the frequency offset is an RB level offset from a first common resource RB to a starting RB of the UL transmission region.

A user equipment (UE) is described. The UE includes reception unit configured to receive, from a base station, a cell-specific TDD UL/DL configuration; and control unit configured to use a SCS configuration provided in the cell-specific TDD UL/DL configuration for setting slot format per slot over a number of slots, wherein each symbol with the used SCS configuration is indicated as downlink symbol, flexible symbol, or uplink symbol by the cell-specific TDD UL/DL configuration, and to use the SCS configuration to determine a time offset and/or a frequency offset for an UL transmission region wherein the UL transmission region is configured in symbols indicated as downlink symbol, the time offset is a symbol level offset from a starting symbol of the number of slots to a starting symbol of the UL transmission region, and the frequency offset is an RB level offset from a first common resource RB to a starting RB of the UL transmission region.

A base station is described. The base station includes transmission unit configured to transmit, to a user equipment (UE), a cell-specific TDD UL/DL configuration; and control unit configured to use a SCS configuration provided in the cell-specific TDD UL/DL configuration for setting slot format per slot over a number of slots, wherein each symbol with the used SCS configuration is indicated as downlink symbol, flexible symbol, or uplink symbol by the cell-specific TDD UL/DL configuration, and to use the SCS configuration to determine a time offset and/or a frequency offset for an UL transmission region wherein the UL transmission region is configured in symbols indicated as downlink symbol, the time offset is a symbol level offset from a starting symbol of the number of slots to a starting symbol of the UL transmission region, and the frequency offset is an RB level offset from a first common resource RB to a starting RB of the UL transmission region.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN). 3GPP NR (New Radio) is the name given to a project to improve the LTE mobile phone or device standard to cope with future requirements. In one aspect, LTE has been modified to provide support and specification (TS 38.331, 38.321, 38.300, 38.211, 38.212, 38.213, 38.214, etc.) for the New Radio Access (NR) and Next generation-Radio Access Network (NG-RAN).

At least some aspects of the systems and methods disclosed herein may be described in relation to the 3GPP LTE, LTE-Advanced (LTE-A), LTE-Advanced Pro, New Radio Access (NR), and other 3G/4G/5G standards (e.g., 3GPP Releases 8, 9, 10, 11, 12, 13, 14, 15, and/or 16, and/or Narrow Band-Internet of Things (NB-IoT)). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE (User Equipment), an access terminal, a subscriber station, a mobile terminal, a remote station, a user terminal, a terminal, a subscriber unit, a mobile device, a relay node, etc. Examples of wireless communication devices include cellular phones, smart phones, personal digital assistants (PDAs), laptop computers, netbooks, e-readers, wireless modems, industrial wireless sensors, video surveillance, wearables, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.”

In 3GPP specifications, a base station is typically referred to as a gNB, a Node B, an eNB, a home enhanced or evolved Node B (HeNB) or some other similar terminology. As the scope of the disclosure should not be limited to 3GPP standards, the terms “base station,”, “gNB”, “Node B,” “eNB,” and “HeNB” may be used interchangeably herein to mean the more general term “base station.” Furthermore, one example of a “base station” is an access point. An access point may be an electronic device that provides access to a network (e.g., Local Area Network (LAN), the Internet, etc.) for wireless communication devices. The term “communication device” may be used to denote both a wireless communication device and/or a base station.

It should be noted that as used herein, a “cell” may be any communication channel that is specified by standardization or regulatory bodies to be used for International Mobile Telecommunications-Advanced (IMT-Advanced), IMT-2020 (5G) and all of it or a subset of it may be adopted by 3GPP as licensed bands (e.g., frequency bands) to be used for communication between a base station and a UE. It should also be noted that in NR, NG-RAN, E-UTRA and E-UTRAN overall description, as used herein, a “cell” may be defined as “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware and is allowed by a base station to transmit or receive information. “Configured cell(s)” may be serving cell(s). The UE may receive system information and perform the required measurements on configured cells. “Configured cell(s)” for a radio connection may consist of a primary cell and/or no, one, or more secondary cell(s). “Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

The base stations may be connected by the NG interface to the 5G-core network (5G-CN). 5G-CN may be called as to NextGen core (NGC), or 5G core (5GC). The base stations may also be connected by the S1 interface to the evolved packet core (EPC). For instance, the base stations may be connected to a NextGen (NG) mobility management function by the NG-2 interface and to the NG core User Plane (UP) functions by the NG-3 interface. The NG interface supports a many-to-many relation between NG mobility management functions, NG core UP functions and the base stations. The NG-2 interface is the NG interface for the control plane and the NG-3 interface is the NG interface for the user plane. For instance, for EPC connection, the base stations may be connected to a mobility management entity (MME) by the S1-MME interface and to the serving gateway (S-GW) by the S1-U interface. The S1 interface supports a many-to-many relation between MMEs, serving gateways and the base stations. The S1-MME interface is the S1 interface for the control plane and the S1-U interface is the S1 interface for the user plane. The Uu interface is a radio interface between the UE and the base station for the radio protocol.

The radio protocol architecture may include the user plane and the control plane. The user plane protocol stack may include packet data convergence protocol (PDCP), radio link control (RLC), medium access control (MAC) and physical (PHY) layers. A DRB (Data Radio Bearer) is a radio bearer that carries user data (as opposed to control plane signaling). For example, a DRB may be mapped to the user plane protocol stack. The PDCP, RLC, MAC and PHY sublayers (terminated at the base station 460a on the network) may perform functions (e.g., header compression, ciphering, scheduling, ARQ and HARQ) for the user plane. PDCP entities are located in the PDCP sublayer. RLC entities may be located in the RLC sublayer. MAC entities may be located in the MAC sublayer. The PHY entities may be located in the PHY sublayer.

The control plane may include a control plane protocol stack. The PDCP sublayer (terminated in base station on the network side) may perform functions (e.g., ciphering and integrity protection) for the control plane. The RLC and MAC sublayers (terminated in base station on the network side) may perform the same functions as for the user plane. The Radio Resource Control (RRC) (terminated in base station on the network side) may perform the following functions. The RRC may perform broadcast functions, paging, RRC connection management, radio bearer (RB) control, mobility functions, UE measurement reporting and control. The Non-Access Stratum (NAS) control protocol (terminated in MME on the network side) may perform, among other things, evolved packet system (EPS) bearer management, authentication, evolved packet system connection management (ECM)-IDLE mobility handling, paging origination in ECM-IDLE and security control.

Signaling Radio Bearers (SRBs) are Radio Bearers (RB) that may be used only for the transmission of RRC and NAS messages. Three SRBs may be defined. SRB0 may be used for RRC messages using the common control channel (CCCH) logical channel. SRB1 may be used for RRC messages (which may include a piggybacked NAS message) as well as for NAS messages prior to the establishment of SRB2, all using the dedicated control channel (DCCH) logical channel. SRB2 may be used for RRC messages which include logged measurement information as well as for NAS messages, all using the DCCH logical channel. SRB2 has a lower-priority than SRB1 and may be configured by a network (e.g., base station) after security activation. A broadcast control channel (BCCH) logical channel may be used for broadcasting system information. Some of BCCH logical channel may convey system information which may be sent from the network to the UE via BCH (Broadcast Channel) transport channel. BCH may be sent on a physical broadcast channel (PBCH). Some of BCCH logical channel may convey system information which may be sent from the network to the UE via DL-SCH (Downlink Shared Channel) transport channel. Paging may be provided by using paging control channel (PCCH) logical channel.

For example, the DL-DCCH logical channel may be used (but not limited to) for a RRC reconfiguration message, a RRC reestablishment message, a RRC release, a UE Capability Enquiry message, a DL Information Transfer message or a Security Mode Command message. UL-DCCH logical channel may be used (but not limited to) for a measurement report message, a RRC Reconfiguration Complete message, a RRC Reestablishment Complete message, a RRC Setup Complete message, a Security Mode Complete message, a Security Mode Failure message, a UE Capability Information, message, a UL Handover Preparation Transfer message, a UL Information Transfer message, a Counter Check Response message, a UE Information Response message, a Proximity Indication message, a RN (Relay Node) Reconfiguration Complete message, an MBMS Counting Response message, an inter Frequency RSTD Measurement Indication message, a UE Assistance Information message, an In-device Coexistence Indication message, an MBMS Interest Indication message, an SCG Failure Information message. DL-CCCH logical channel may be used (but not limited to) for a RRC Connection Reestablishment message, a RRC Reestablishment Reject message, a RRC Reject message, or a RRC Setup message. UL-CCCH logical channel may be used (but not limited to) for a RRC Reestablishment Request message, or a RRC Setup Request message.

System information may be divided into the MasterInformationBlock (MIB) and a number of SystemInformationBlocks (SIBs).

The UE may receive one or more RRC messages from the base station to obtain RRC configurations or parameters. The RRC layer of the UE may configure RRC layer and/or lower layers (e.g., PHY layer, MAC layer, RLC layer, PDCP layer) of the UE according to the RRC configurations or parameters which may be configured by the RRC messages, broadcasted system information, and so on. The base station may transmit one or more RRC messages to the UE to cause the UE to configure RRC layer and/or lower layers of the UE according to the RRC configurations or parameters which may be configured by the RRC messages, broadcasted system information, and so on.

When carrier aggregation is configured, the UE may have one RRC connection with the network. One radio interface may provide carrier aggregation. During RRC establishment, re-establishment and handover, one serving cell may provide Non-Access Stratum (NAS) mobility information (e.g., a tracking area identity (TAI)). During RRC re-establishment and handover, one serving cell may provide a security input. This cell may be referred to as the primary cell (PCell). In the downlink, the component carrier corresponding to the PCell may be the downlink primary component carrier (DL PCC), while in the uplink it may be the uplink primary component carrier (UL PCC). In the present disclosure, the terms “component carrier” and “carrier” can be interchanged with each other.

Depending on UE capabilities, one or more SCells may be configured to form together with the PCell a set of serving cells. In the downlink, the component carrier corresponding to an SCell may be a downlink secondary component carrier (DL SCC), while in the uplink it may be an uplink secondary component carrier (UL SCC).

The configured set of serving cells for the UE, therefore, may consist of one PCell and one or more SCells. For each SCell, the usage of uplink resources by the UE (in addition to the downlink resources) may be configurable. The number of DL SCCs configured may be larger than or equal to the number of UL SCCs and no SCell may be configured for usage of uplink resources only.

From a UE viewpoint, each uplink resource may belong to one serving cell. The number of serving cells that may be configured depends on the aggregation capability of the UE. The PCell may only be changed using a handover procedure (e.g., with a security key change and a random access procedure). A PCell may be used for transmission of the PUCCH. A primary secondary cell (PSCell) may also be used for transmission of the PUCCH. The PSCell may be referred to as a primary SCG cell or SpCell of a secondary cell group. The PCell or PSCell may not be de-activated. Re-establishment may be triggered when the PCell experiences radio link failure (RLF), not when the SCells experience RLF. Furthermore, NAS information may be taken from the PCell.

The reconfiguration, addition and removal of SCells may be performed by RRC. At handover or reconfiguration with sync, Radio Resource Control (RRC) layer may also add, remove or reconfigure SCells for usage with a target PCell. When adding a new SCell, dedicated RRC signaling may be used for sending all required system information of the SCell (e.g., while in connected mode, UEs need not acquire broadcasted system information directly from the SCells).

The systems and methods described herein may enhance the efficient use of radio resources in Carrier aggregation (CA) operation. Carrier aggregation refers to the concurrent utilization of more than one component carrier (CC). In carrier aggregation, more than one cell may be aggregated to a UE. In one example, carrier aggregation may be used to increase the effective bandwidth available to a UE. In traditional carrier aggregation, a single base station is assumed to provide multiple serving cells for a UE. Even in scenarios where two or more cells may be aggregated (e.g., a macro cell aggregated with remote radio head (RRH) cells) the cells may be controlled (e.g., scheduled) by a single base station. However, in a small cell deployment scenario, each node (e.g., base station, RRH, etc.) may have its own independent scheduler. To maximize the efficiency of radio resources utilization of both nodes, a UE may connect to two or more nodes that have different schedulers. The systems and methods described herein may enhance the efficient use of radio resources in dual connectivity operation. A UE may be configured multiple groups of serving cells, where each group may have carrier aggregation operation (e.g., if the group includes more than one serving cell).

In Dual Connectivity (DC) the UE may be required to be capable of UL-CA with simultaneous PUCCH/PUCCH and PUCCH/PUSCH transmissions across cell-groups (CGs). In a small cell deployment scenario, each node (e.g., eNB, RRH, etc.) may have its own independent scheduler. To maximize the efficiency of radio resources utilization of both nodes, a UE may connect to two or more nodes that have different schedulers. A UE may be configured multiple groups of serving cells, where each group may have carrier aggregation operation (e.g., if the group includes more than one serving cell). A UE in RRC_CONNECTED may be configured with Dual Connectivity or MR-DC, when configured with a Master and a Secondary Cell Group. A Cell Group (CG) may be a subset of the serving cells of a UE, configured with Dual Connectivity (DC) or MR-DC, i.e. a Master Cell Group (MCG) or a Secondary Cell Group (SCG). The Master Cell Group may be a group of serving cells of a UE comprising of the PCell and zero or more secondary cells. The Secondary Cell Group (SCG) may be a group of secondary cells of a UE, configured with DC or MR-DC, comprising of the PSCell and zero or more other secondary cells. A Primary Secondary Cell (PSCell) may be the SCG cell in which the UE is instructed to perform random access when performing the SCG change procedure. “PSCell” may be also called as a Primary SCG Cell. In Dual Connectivity or MR-DC, two MAC entities may be configured in the UE: one for the MCG and one for the SCG. Each MAC entity may be configured by RRC with a serving cell supporting PUCCH transmission and contention based Random Access. In a MAC layer, the term Special Cell (SpCell) may refer to such cell, whereas the term SCell may refer to other serving cells. The term SpCell either may refer to the PCell of the MCG or the PSCell of the SCG depending on if the MAC entity is associated to the MCG or the SCG, respectively. A Timing Advance Group (TAG) containing the SpCell of a MAC entity may be referred to as primary TAG (pTAG), whereas the term secondary TAG (sTAG) refers to other TAGs.

DC may be further enhanced to support Multi-RAT Dual Connectivity (MR-DC). MR-DC may be a generalization of the Intra-E-UTRA Dual Connectivity (DC) described in 36.300, where a multiple Rx/Tx UE may be configured to utilize resources provided by two different nodes connected via non-ideal backhaul, one providing E-UTRA access and the other one providing NR access. One node acts as a Mater Node (MN) and the other as a Secondary Node (SN). The MN and SN are connected via a network interface and at least the MN is connected to the core network. In DC, a PSCell may be a primary secondary cell. In EN-DC, a PSCell may be a primary SCG cell or SpCell of a secondary cell group.

E-UTRAN may support MR-DC via E-UTRA-NR Dual Connectivity (EN-DC), in which a UE is connected to one eNB that acts as a MN and one en-gNB that acts as a SN. The en-gNB is a node providing NR user plane and control plane protocol terminations towards the UE, and acting as Secondary Node in EN-DC. The eNB is connected to the EPC via the S1 interface and to the en-gNB via the X2 interface. The en-gNB might also be connected to the EPC via the S1-U interface and other en-gNBs via the X2-U interface.

A timer is running once it is started, until it is stopped or until it expires; otherwise it is not running. A timer can be started if it is not running or restarted if it is running. A Timer may be always started or restarted from its initial value.

For NR, a technology of aggregating NR carriers may be studied. Both lower layer aggregation like Carrier Aggregation (CA) for LTE and upper layer aggregation like DC are investigated. From layer 2/3 point of view, aggregation of carriers with different numerologies may be supported in NR.

The main services and functions of the RRC sublayer may include the following:
Broadcast of System Information related to Access Stratum (AS) and Non Access Stratum (NAS);
Paging initiated by CN or RAN;
Establishment, maintenance and release of an RRC connection between the UE and NR RAN including:
Addition, modification and release of carrier aggregation;
Addition, modification and release of Dual Connectivity in NR or between LTE and NR;
Security functions including key management;
Establishment, configuration, maintenance and release of signaling radio bearers and data radio bearers;
Mobility functions including:
Handover;
UE cell selection and reselection and control of cell selection and reselection;
Context transfer at handover.
QoS management functions;
UE measurement reporting and control of the reporting;
NAS message transfer to/from NAS from/to UE.

Each MAC entity of a UE may be configured by RRC with a Discontinuous Reception (DRX) functionality that controls the UE's PDCCH monitoring activity for the MAC entity's C-RNTI (Radio Network Temporary Identifier), CS-RNTI, INT-RNTI, SFI-RNTI, SP-CSI-RNTI, TPC-PUCCH-RNTI, TPC-PUSCH-RNTI, and TPC-SRS-RNTI. For scheduling at cell level, the following identities are used:
C (Cell)-RNTI: unique UE identification used as an identifier of the RRC Connection and for scheduling;
CS (Configured Scheduling)-RNTI: unique UE identification used for Semi-Persistent Scheduling in the downlink;
INT-RNTI: identification of pre-emption in the downlink;
P-RNTI: identification of Paging and System Information change notification in the downlink;
SI-RNTI: identification of Broadcast and System Information in the downlink;
SP-CSI-RNTI: unique UE identification used for semi-persistent CSI reporting on PUSCH;
CI-RNTI: Cancellation Indication RNTI for Uplink.
   For power and slot format control, the following identities are used:
SFI-RNTI: identification of slot format;
TPC-PUCCH-RNTI: unique UE identification to control the power of PUCCH;
TPC-PUSCH-RNTI: unique UE identification to control the power of PUSCH;
1 TPC-SRS-RNTI: unique UE identification to control the power of SRS;
   During the random access procedure, the following identities are also used:
RA-RNTI: identification of the Random Access Response in the downlink;
Temporary C-RNTI: UE identification temporarily used for scheduling during the random access procedure;
Random value for contention resolution: UE identification temporarily used for contention resolution purposes during the random access procedure.
   For NR connected to 5GC, the following UE identities are used at NG-RAN level:
I-RNTI: used to identify the UE context in RRC_INACTIVE.

The size of various fields in the time domain is expressed in time units T_{c}=1/(Δfₘₐₓ×N_{f}) where Δfₘₐₓ=480×10³ Hz and N_{f}=4096. The constant κ=Tₛ/T_{c}=64 where Tₛ=1/(Δf_{ref}·N_{f,ref}), Δf_{ref}=15·10³ Hz and N_{f,ref}=2048.

Multiple OFDM numerologies are supported as given by Table 4.2-1 of [TS 38.211] where μ and the cyclic prefix for a bandwidth part are obtained from the higher-layer parameter subcarrierSpacing and cyclicPrefix, respectively.

The size of various fields in the time domain may be expressed as a number of time units T_{c}=1/(15000×2048) seconds. Downlink and uplink transmissions are organized into frames with T_{f}=(ΔfₘₐₓN_{f}/100)·T_{c}=10 ms duration, each consisting of ten subframes of T_{sf}=(ΔfₘₐₓN_{f}/1000)·T_{c}=1 ms duration. The number of consecutive OFDM symbols per subframe is

$${N}_{s y m b}^{subframe , μ} = {N}_{s y m b}^{s l o t} {N}_{s l o t}^{subfrαme , μ} .$$

Each frame is divided into two equally-sized half-frames of five subframes each with half-frame 0 consisting of subframes 0-4 and half-frame 1 consisting of subframes 5-9.

For subcarrier spacing (SCS) configuration μ, slots are numbered

$${n}_{s}^{μ} ∈ \{ 0 , … , {N}_{s l o t}^{subframe , μ} - 1 \}$$

in increasing order within a subframe and

$${n}_{s , f}^{μ} ∈ \{ 0 , … , {N}_{s l o t}^{frame , μ} - 1 \}$$

in increasing order within a frame.

$${N}_{s l o t}^{subframe , μ}$$

is the number of slots per subframe for subcarrier spacing configuration μ. There are

$${N}_{s y m b}^{slot}$$

consecutive OFDM symbols in a slot where

$${N}_{s y m b}^{s l o t}$$

depends on the cyclic prefix as given by Tables 4.3.2-1 and 4.3.2-2 of [TS 38.211]. The start of slot

$${n}_{s}^{μ}$$

in a subframe is aligned in time with the start of OFDM symbol

$${n}_{s}^{μ} {N}_{s y m b}^{s l o t}$$

in the same subframe. Subcarrier spacing refers to a spacing (or frequency bandwidth) between two consecutive subcarrier in the frequency domain. For example, the subcarrier spacing can be set to 15 kHz (i.e. μ=0), 30 kHz (i.e. μ=1), 60 kHz (i.e. μ=2), 120 kHz (i.e. μ=3), or 240 kHz (i.e. μ=4). A resource block is defined as a number of consecutive subcarriers (e.g. 12) in the frequency domain. For a carrier with different frequency, the applicable subcarrier may be different. For example, for a carrier in a frequency rang 1, a subcarrier spacing only among a set of {15 kHz, 30 kHz, 60 kHz} is applicable. For a carrier in a frequency rang 2, a subcarrier spacing only among a set of {60 kHz, 120 kHz, 240 kHz} is applicable. The base station may not configure an inapplicable subcarrier spacing for a carrier.

OFDM symbols in a slot can be classified as ‘downlink’, ‘flexible’, or ‘uplink’. Signaling of slot formats is described in subclause 11.1 of [TS 38.213].

In a slot in a downlink frame, the UE may assume that downlink transmissions only occur in ‘downlink’ or ‘flexible’ symbols. In a slot in an uplink frame, the UE may only transmit in ‘uplink’ or ‘flexible’ symbols.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

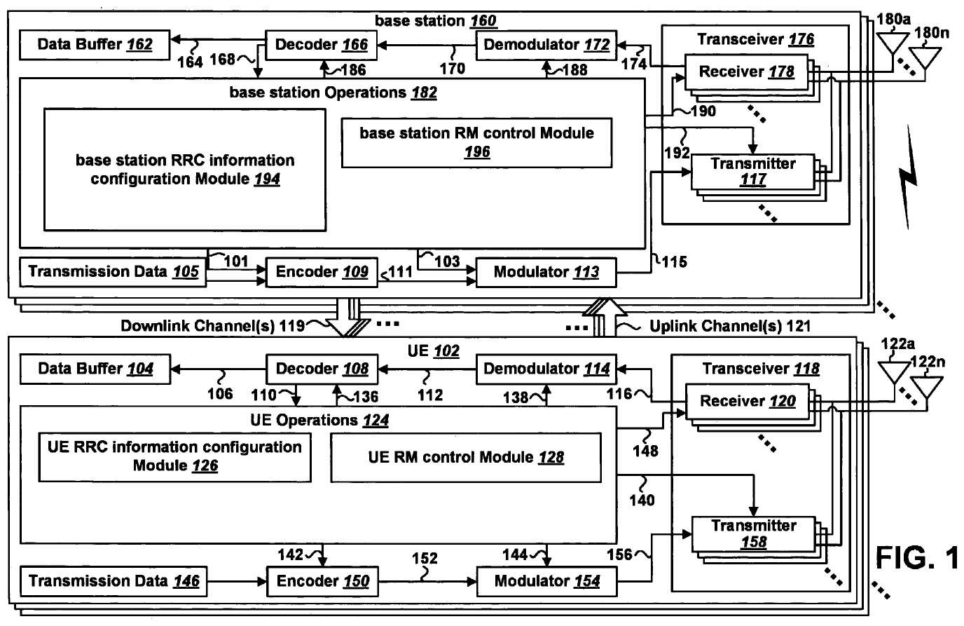

FIG. 1 is a block diagram illustrating one configuration of one or more base stations 160 (e.g., eNB, gNB) and one or more user equipments (UEs) 102 in which systems and methods for how to determine SCS configuration for an UL transmission region may be implemented. The one or more UEs 102 may communicate with one or more base stations 160 using one or more antennas 122a-n. For example, a UE 102 transmits electromagnetic signals to the base station 160 and receives electromagnetic signals from the base station 160 using the one or more antennas 122a-n. The base station 160 communicates with the UE 102 using one or more antennas 180a-n.

It should be noted that in some configurations, one or more of the UEs 102 described herein may be implemented in a single device. For example, multiple UEs 102 may be combined into a single device in some implementations. Additionally or alternatively, in some configurations, one or more of the base stations 160 described herein may be implemented in a single device. For example, multiple base stations 160 may be combined into a single device in some implementations. In the context of FIG. 1, for instance, a single device may include one or more UEs 102 in accordance with the systems and methods described herein. Additionally or alternatively, one or more base stations 160 in accordance with the systems and methods described herein may be implemented as a single device or multiple devices.

The UE 102 and the base station 160 may use one or more channels 119, 121 to communicate with each other. For example, a UE 102 may transmit information or data to the base station 160 using one or more uplink (UL) channels 121 and signals. Examples of uplink channels 121 include a physical uplink control channel (PUCCH) and a physical uplink shared channel (PUSCH), etc. Examples of uplink signals include a demodulation reference signal (DMRS) and a sounding reference signal (SRS), etc. The one or more base stations 160 may also transmit information or data to the one or more UEs 102 using one or more downlink (DL) channels 119 and signals, for instance. Examples of downlink channels 119 include a PDCCH, a PDSCH, etc. A PDCCH can be used to schedule DL transmissions on PDSCH and UL transmissions on PUSCH, where the Downlink Control Information (DCI) on PDCCH includes downlink assignment and uplink scheduling grants. The PDCCH is used for transmitting Downlink Control Information (DCI) in a case of downlink radio communication (radio communication from the base station to the UE). Here, one or more DCIs (may be referred to as DCI formats) are defined for transmission of downlink control information. Information bits are mapped to one or more fields defined in a DCI format. Examples of downlink signals include a primary synchronization signal (PSS), a secondary synchronization signal (SSS), a cell-specific reference signal (CRS), a non-zero power channel state information reference signal (NZP CSI-RS), and a zero power channel state information reference signal (ZP CSI-RS), etc. Other kinds of channels or signals may be used.

Each of the one or more UEs 102 may include one or more transceivers 118, one or more demodulators 114, one or more decoders 108, one or more encoders 150, one or more modulators 154, one or more data buffers 104 and one or more UE operations modules 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals (e.g., downlink channels, downlink signals) from the base station 160 using one or more antennas 122a-n. For example, the receiver 120 may receive and downconvert signals to produce one or more received signals 116. The one or more received signals 116 may be provided to a demodulator 114. The one or more transmitters 158 may transmit signals (e.g., uplink channels, uplink signals) to the base station 160 using one or more antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce one or more decoded signals 106, 110. For example, a first UE-decoded signal 106 may comprise received payload data, which may be stored in a data buffer 104. A second UE-decoded signal 110 may comprise overhead data and/or control data. For example, the second UE-decoded signal 110 may provide data that may be used by the UE operations module 124 to perform one or more operations.

As used herein, the term “module” may mean that a particular element or component may be implemented in hardware, software or a combination of hardware and software. However, it should be noted that any element denoted as a “module” herein may alternatively be implemented in hardware. For example, the UE operations module 124 may be implemented in hardware, software or a combination of both.

In general, the UE operations module 124 may enable the UE 102 to communicate with the one or more base stations 160. The UE operations module 124 may include a UE RRC information configuration module 126. The UE operations module 124 may include a UE resource management (RM) control module 128. In some implementations, the UE operations module 124 may include physical (PHY) entities, Medium Access Control (MAC) entities, Radio Link Control (RLC) entities, packet data convergence protocol (PDCP) entities, and a Radio Resource Control (RRC) entity. For example, the UE RRC information configuration module 126 may process RRC parameter(s) included in cell-specific TDD UL/DL configuration and in a configuration of UL transmission region. The UE RM control module 128 may determine that a subcarrier spacing configuration provided in the cell-specific TDD UL/DL configuration is used for the UL transmission region. The UE RM control module 128 may use the determined subcarrier spacing configuration to determine time-frequency resource of the UL transmission region.

The UE operations module 124 may provide information 148 to the one or more receivers 120. For example, the UE operations module 124 may inform the receiver(s) 120 when or when not to receive transmissions based on the Radio Resource Control (RRC) message (e.g., broadcasted system information, RRC reconfiguration message), MAC control element, and/or the DCI (Downlink Control Information). The UE operations module 124 may provide information 148, including the PDCCH monitoring occasions and DCI format size, to the one or more receivers 120. The UE operation module 124 may inform the receiver(s) 120 when or where to receive/monitor the PDCCH candidate for DCI formats with which DCI size.

The UE operations module 124 may provide information 138 to the demodulator 114. For example, the UE operations module 124 may inform the demodulator 114 of a modulation pattern anticipated for transmissions from the base station 160.

The UE operations module 124 may provide information 136 to the decoder 108. For example, the UE operations module 124 may inform the decoder 108 of an anticipated encoding for transmissions from the base station 160. For example, the UE operations module 124 may inform the decoder 108 of an anticipated PDCCH candidate encoding with which DCI size for transmissions from the base station 160.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142.

The encoder 150 may encode transmission data 146 and/or other information 142 provided by the UE operations module 124. For example, encoding the data 146 and/or other information 142 may involve error detection and/or correction coding, mapping data to space, time and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the base station 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the base station 160. The one or more transmitters 158 may upconvert and transmit the modulated signal(s) 156 to one or more base stations 160.

The base station 160 may include one or more transceivers 176, one or more demodulators 172, one or more decoders 166, one or more encoders 109, one or more modulators 113, one or more data buffers 162 and one or more base station operations modules 182. For example, one or more reception and/or transmission paths may be implemented in a base station 160. For convenience, only a single transceiver 176, decoder 166, demodulator 172, encoder 109 and modulator 113 are illustrated in the base station 160, though multiple parallel elements (e.g., transceivers 176, decoders 166, demodulators 172, encoders 109 and modulators 113) may be implemented.

The transceiver 176 may include one or more receivers 178 and one or more transmitters 117. The one or more receivers 178 may receive signals (e.g., uplink channels, uplink signals) from the UE 102 using one or more antennas 180a-n. For example, the receiver 178 may receive and downconvert signals to produce one or more received signals 174. The one or more received signals 174 may be provided to a demodulator 172. The one or more transmitters 117 may transmit signals (e.g., downlink channels, downlink signals) to the UE 102 using one or more antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The base station 160 may use the decoder 166 to decode signals. The decoder 166 may produce one or more decoded signals 164, 168. For example, a first base station-decoded signal 164 may comprise received payload data, which may be stored in a data buffer 162. A second base station-decoded signal 168 may comprise overhead data and/or control data. For example, the second base station-decoded signal 168 may provide data (e.g., PUSCH transmission data) that may be used by the base station operations module 182 to perform one or more operations.

In general, the base station operations module 182 may enable the base station 160 to communicate with the one or more UEs 102. The base station operations module 182 may include a base station RRC information configuration module 194. The base station operations module 182 may include a base station resource management (RM) control module 196 (or a base station RM processing module 196). The base station operations module 182 may include PHY entities, MAC entities, RLC entities, PDCP entities, and an RRC entity.

The base station RM control module 196 may determine, for respective UE, cell-specific TDD UL/DL configuration and a configuration of UL transmission region and input the information to the base station RRC information configuration module 194. The base station RM control module 196 may determine a subcarrier spacing configuration provided in the cell-specific TDD UL/DL configuration is used for the UL transmission region. The base station RM control module 196 may use the determined subcarrier spacing configuration to determine time-frequency resource of the UL transmission region.

The base station operations module 182 may provide the benefit of performing PDCCH candidate search and monitoring efficiently. The base station operations module 182 may provide information 190 to the one or more receivers 178. For example, the base station operations module 182 may inform the receiver(s) 178 when or when not to receive transmissions based on the RRC message (e.g., broadcasted system information, RRC reconfiguration message), MAC control element, and/or the DCI (Downlink Control Information).

The base station operations module 182 may provide information 188 to the demodulator 172. For example, the base station operations module 182 may inform the demodulator 172 of a modulation pattern anticipated for transmissions from the UE(s) 102.

The base station operations module 182 may provide information 186 to the decoder 166. For example, the base station operations module 182 may inform the decoder 166 of an anticipated encoding for transmissions from the UE(s) 102.

The base station operations module 182 may provide information 101 to the encoder 109. The information 101 may include data to be encoded and/or instructions for encoding. For example, the base station operations module 182 may instruct the encoder 109 to encode transmission data 105 and/or other information 101.

In general, the base station operations module 182 may enable the base station 160 to communicate with one or more network nodes (e.g., a NG mobility management function, a NG core UP functions, a mobility management entity (MME), serving gateway (S-GW), gNBs). The base station operations module 182 may also generate a RRC reconfiguration message to be signaled to the UE 102.

The encoder 109 may encode transmission data 105 and/or other information 101 provided by the base station operations module 182. For example, encoding the data 105 and/or other information 101 may involve error detection and/or correction coding, mapping data to space, time and/or frequency resources for transmission, multiplexing, etc. The encoder 109 may provide encoded data 111 to the modulator 113. The transmission data 105 may include network data to be relayed to the UE 102.

The base station operations module 182 may provide information 103 to the modulator 113. This information 103 may include instructions for the modulator 113. For example, the base station operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The base station operations module 182 may provide information 192 to the one or more transmitters 117. This information 192 may include instructions for the one or more transmitters 117. For example, the base station operations module 182 may instruct the one or more transmitters 117 when to (or when not to) transmit a signal to the UE(s) 102. The base station operations module 182 may provide information 192, including the PDCCH monitoring occasions and DCI format size, to the one or more transmitters 117. The base station operation module 182 may inform the transmitter(s) 117 when or where to transmit the PDCCH candidate for DCI formats with which DCI size. The one or more transmitters 117 may upconvert and transmit the modulated signal(s) 115 to one or more UEs 102.

It should be noted that one or more of the elements or parts thereof included in the base station(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

A base station may generate a RRC message including the one or more RRC parameters, and transmit the RRC message to a UE. A UE may receive, from a base station, a RRC message including one or more RRC parameters. The term ‘RRC parameter(s)’ in the present disclosure may be alternatively referred to as ‘RRC information element(s)’. A RRC parameter may further include one or more RRC parameter(s). In the present disclosure, a RRC message may include system information. a RRC message may include one or more RRC parameters. A RRC message may be sent on a broadcast control channel (BCCH) logical channel, a common control channel (CCCH) logical channel or a dedicated control channel (DCCH) logical channel.

In the present disclosure, a description ‘a base station may configure a UE to’ may also imply/refer to ‘a base station may transmit, to a UE, an RRC message including one or more RRC parameters’. Additionally or alternatively, ‘RRC parameter configure a UE to’ may also refer to ‘a base station may transmit, to a UE, an RRC message including one or more RRC parameters’. Additionally or alternatively, ‘a UE is configured to’ may also refer to ‘a UE may receive, from a base station, an RRC message including one or more RRC parameters’.

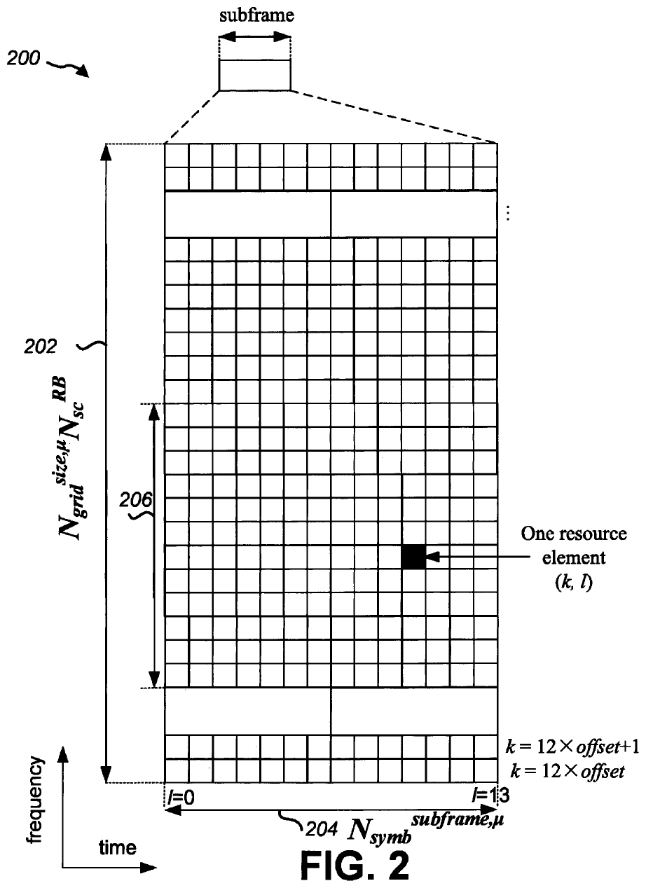

FIG. 2 is a diagram illustrating one example of a resource grid 200.

For each numerology and carrier, a resource grid of

$${N}_{grid , x} {}^{size , μ} {N}_{s c}^{R B}$$

subcarriers and N_{symb}^{subframe,μ} OFDM symbols is defined, starting at common resource block N_{grid}^{start,μ} indicated by higher layer signaling. There is one set of resource grids per transmission direction (uplink or downlink) with the subscript x set to DL and UL for downlink and uplink, respectively. There is one resource grid for a given antenna port p, subcarrier spacing configuration μ, and the transmission direction (downlink or uplink). When there is no risk for confusion, the subscript x may be dropped.

In the FIG. 2, the resource gird 200 includes the

$${N}_{grid , x} {}^{size , μ} {N}_{s c}^{R B}$$

(202) subcarriers in the frequency domain and includes N_{symb}^{subframe,μ} (204) symbols in the time domain. In the FIG. 2, as an example for illustration, the subcarrier spacing configuration μ is set to 0. That is, in the FIG. 2, the number of consecutive OFDM symbols N_{symb}^{subframe,μ} (204) per subframe is equal to 14.

The carrier bandwidth N_{grid}^{size,μ} (N_{grid,x}^{size,μ}) for subcarrier spacing configuration μ is given by the higher-layer (RRC) parameter carrierBandwidth in the SCS-SpecificCarrier IE. The starting position N_{grid}^{start,μ} for subcarrier spacing configuration μ is given by the higher-layer parameter offsetToCarrier in the SCS-SpecificCarrier IE. The frequency location of a subcarrier refers to the center frequency of that subcarrier. One or more subcarrier spacing configuration can be configured for a carrier. A parameter SCS-SpecificCarrierList may include one or more SCS-SpecificCarrier IEs where each SCS-SpecificCarrier is used to indicate a carrier bandwidth and location for a subcarrier spacing configuration.

In the FIG. 2, for example, a value of offset is provided by the higher-layer parameter offsetToCarrier. That is, k=12×offset is the lowest usable subcarrier on this carrier.

Each element in the resource grid for antenna port p and subcarrier spacing configuration μ is called a resource element and is uniquely identified by (k, l)_{p,μ} where k is the index in the frequency domain and l refers to the symbols position in the time domain relative to same reference point. The resource element consists of one subcarrier during one OFDM symbol.

A resource block is defined as N_{sc}^{RB}=12 consecutive subcarriers in the frequency domain. As shown in the FIG. 2, a resource block 206 includes 12 consecutive subcarriers in the frequency domain. Resource block can be classified as common resource block (CRB) and physical resource block (PRB).

Common resource blocks are numbered from 0 and upwards in the frequency domain for subcarrier spacing configuration μ. The center of subcarrier 0 of common resource block with index 0 (i.e. CRB0) for subcarrier spacing configuration μ coincides with point A. The relation between the common resource block number

$${n}_{C R B}^{μ}$$

in the frequency domain and resource element (k, l) for subcarrier spacing configuration μ is given by Formula (1) n_{CRB}^{μ}=floor(k/N_{sc}^{RB}) where k is defined relative to the point A such that k=0 corresponds to the subcarrier centered around the point A. The function floor (A) hereinafter is to output a maximum integer not larger than the A.

Point A refers to as a common reference point. Point A coincides with subcarrier 0 (i.e. k=0) of a CRB 0 for all subcarrier spacing. Point A can be obtained from a RRC parameter offsetToPointA or a RRC parameter absoluteFrequencyPointA. The RRC parameter offsetToPointA is used for a PCell downlink and represents the frequency offset between point A and the lowest subcarrier of the lowest resource block, which has the subcarrier spacing provided by a higher-layer parameter subCarrierSpacingCommon and overlaps with the SS/PBCH block used by the UE for initial cell selection, expressed in units of resource blocks assuming 15 kHz subcarrier spacing for frequency range (FR) 1 and 60 kHz subcarrier spacing for frequency range (FR2). FR1 corresponds to a frequency range between 410 MHz and 7125 MHz. FR2 corresponds to a frequency range between 24250 MHz and 52600 MHz. The RRC parameter absoluteFrequencyPointA is used for all cased other than the PCell case and represents the frequency-location of point A expressed as in ARFCN. The frequency location of point A can be the lowest subcarrier of the carrier bandwidth (or the actual carrier). Additionally, point A may be located outside the carrier bandwidth (or the actual carrier).

As above mentioned, the information element (IE) SCS-SpecificCarrier provides parameters determining the location and width of the carrier bandwidth or the actual carrier. That is, a carrier (or a carrier bandwidth, or an actual carrier) is determined (identified, or defined) at least by a RRC parameter offsetToCarrier, a RRC parameter subcarrierSpacing, and a RRC parameter carrierBandwidth in the SCS-SpecificCarrier IE.

The subcarrierSpacing indicates (or defines) a subcarrier spacing of the carrier. The offsetToCarrier indicates an offset in frequency domain between point A and a lowest usable subcarrier on this carrier in number of resource blocks (e.g. CRBs) using the subcarrier spacing defined for the carrier. The carrierBandwidth indicates width of this carrier in number of resource blocks (e.g. CRBs or PRBs) using the subcarrier spacing defined for the carrier. A carrier includes at most 275 resource blocks.

Physical resource block for subcarrier spacing configuration μ are defined within a bandwidth part and numbered form 0 to N_{BWP,i}^{size,μ} where i is the number of the bandwidth part. The relation between the physical resource block n_{PRB}^{μ} in bandwidth part (BWP) i and the common resource block n_{CRB}^{μ} is given by Formula (2) n_{CRB}^{μ}=n_{PRB}^{μ}+N_{BWP,i}^{start, μ} where N_{BWP,i}^{start,μ} is the common resource block where bandwidth part i starts relative to common resource block 0 (CRB0). When there is no risk for confusion the index μ may be dropped.

A BWP is a subset of contiguous common resource block for a given subcarrier spacing configuration μ on a given carrier. To be specific, a BWP can be identified (or defined) at least by a subcarrier spacing u indicated by the RRC parameter subcarrierSpacing, a cyclic prefix determined by the RRC parameter cyclicPrefix, a frequency domain location, a bandwidth, an BWP index indicated by bwp-Id and so on. The locationAndBandwidth can be used to indicate the frequency domain location and bandwidth of a BWP. The value indicated by the locationAndBandwidth is interpreted as resource indicator value (RIV) corresponding to an offset (a starting resource block) RBₛₜₐᵣₜ and a length L_{RB} in terms of contiguously resource blocks. The offset RBₛₜₐᵣₜ is a number of CRBs between the lowest CRB of the carrier and the lowest CRB of the BWP. The N_{BWP,i}^{start, μ} is given as Formula (3) N_{BWP,i}^{start, μ}=O_{carrier}+RBₛₜₐᵣₜ. The value of O_{carrier} is provided by offsetTocarrier for the corresponding subcarrier spacing configuration μ. In other words, the locationAndBandwidth may provide a starting RB index and a number of contiguous RBs for a BWP.

A UE 102 configured to operation in BWPs of a serving cell, is configured by higher layers for the serving cell a set of at most four BWPs in the downlink for reception. At a given time, a single downlink BWP is active. The bases station 160 may not transmit, to the UE 102, PDSCH and/or PDCCH outside the active downlink BWP. A UE 102 configured to operation in BWPs of a serving cell, is configured by higher layers for the serving cell a set of at most four BWPs for transmission. At a given time, a single uplink BWP is active. The UE 102 may not transmit, to the base station 160, PUSCH or PUCCH outside the active BWP. The specific signaling (higher layers signaling) for BWP configurations are described later.

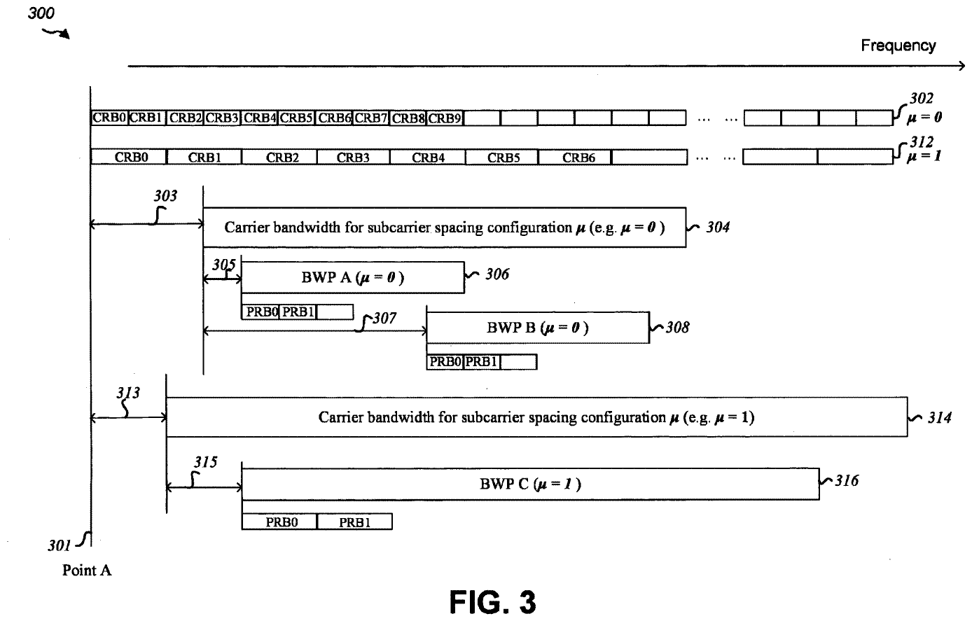

FIG. 3 is a diagram illustrating one example 300 of common resource block grid, carrier configuration and BWP configuration by a UE 102 and a base station 160.

Point A 301 is a lowest subcarrier of a CRB0 for all subcarrier spacing configurations. The CRB grid 302 and the CRB grid 312 are corresponding to two different subcarrier spacing configurations. The CRB grid 302 is for subcarrier spacing configuration μ=0 (i.e. the subcarrier spacing with 15 kHz). The CRB grid 312 is for subcarrier spacing configuration μ=1 (i.e. the subcarrier spacing with 30 kHz).

One or more carriers are determined by respective SCS-SpecificCarrier IEs, respectively. In the FIG. 3, the carrier 304 uses the subcarrier spacing configuration μ=0. And the carrier 314 uses the subcarrier spacing configuration μ=1. The starting position N_{grid}^{start,μ} of the carrier 304 is given based on the value of an offset 303 (i.e. O_{carrier}) indicated by an offsetToCarrier in an SCS-SpecificCarrier IE. As shown in the FIG. 3, for example, the offsetToCarrier indicates the value of the offset 303 as O_{carrier}=3. That is, the starting position N_{grid}^{start,μ} of the carrier 304 corresponds to the CRB3 of the CRB grid 302 for subcarrier spacing configuration μ=0. In the meantime, the starting position N_{grid}^{start,μ} of the carrier 314 is given based on the value of an offset 313 (i.e. O_{carrier}) indicated by an offsetToCarrier in another SCS-SpecificCarrier IE. For example, the offsetToCarrier indicates the value of the offset 313 as O_{carrier}=1. That is, the starting position N_{grid}^{start,μ} of the carrier 314 corresponds to the CRB1 of the CRB grid 312 for subcarrier spacing configuration μ=1. A carrier using different subcarrier spacing configurations can occupy different frequency ranges.

As above-mentioned, a BWP is for a given subcarrier spacing configuration μ. One or more BWPs can be configured for a same subcarrier spacing configuration μ. For example, in the FIG. 3, the BWP 306 is identified at least by the μ=0, a frequency domain location, a bandwidth (L_{RB}), and an BWP index (index A). The first PRB (i.e. PRB0) of a BWP is determined at least by the subcarrier spacing of the BWP, an offset derived by the locationAndBandwidth and an offset indicated by the offsetToCarrier corresponding to the subcarrier spacing of the BWP. An offset 305 (RBₛₜₐᵣₜ) is derived as 1 by the locationAndBandwidth. According to the Formulas (2) and (3), the PRB0 of BWP 306 corresponds to CRB 4 of the CRB grid 302, and the PRB1 of BWP 306 corresponds to CRB 5 of the CRB grid 302, and so on.

Additionally, in the FIG. 3, the BWP 308 is identified at least by the μ=0, a frequency domain location, a bandwidth (L_{RB}), and an BWP index (index B). For example, an offset 307 (RBₛₜₐᵣₜ) is derived as 6 by the locationAndBandwidth. According to the Formulas (2) and (3), the PRB0 of BWP 308 corresponds to CRB 9 of the CRB grid 302, and the PRB1 of BWP 308 corresponds to CRB 10 of the CRB grid 302, and so on.

Additionally, in the FIG. 3, the BWP 316 is identified at least by the μ=1, a frequency domain location, a bandwidth (L_{RB}), and an BWP index (index C). For example, an offset 315 (RBₛₜₐᵣₜ) is derived as 1 by the locationAndBandwidth. According to the Formulas (2) and (3), the PRB0 of BWP 316 corresponds to CRB 2 of the CRB grid 312, and the PRB1 of BWP 316 corresponds to CRB 3 of the CRB grid 312, and so on.

As shown in the FIG. 3, a carrier with the defined subcarrier spacing locate in a corresponding CRB grid with the same subcarrier spacing. A BWP with the defined subcarrier spacing locate in a corresponding CRB grid with the same subcarrier spacing as well.

A base station may transmit a RRC message including one or more RRC parameters related to BWP configuration to a UE. A UE may receive the RRC message including one or more RRC parameters related to BWP configuration from a base station. For each cell, the base station may configure at least an initial DL BWP and one initial uplink bandwidth parts (initial UL BWP) to the UE. Furthermore, the base station may configure additional UL and DL BWPs to the UE for a cell.

A RRC parameters initialDownlinkBWP may indicate the initial downlink BWP (initial DL BWP) configuration for a serving cell (e.g., a SpCell and Scell). The base station may configure the RRC parameter locationAndBandwidth included in the initialDownlinkBWP so that the initial DL BWP contains the entire CORESET #0 of this serving cell in the frequency domain. The locationAndBandwidth may be used to indicate the frequency domain location and bandwidth of a BWP. A RRC parameters initialUplinkBWP may indicate the initial uplink BWP (initial UL BWP) configuration for a serving cell (e.g., a SpCell and Scell). The base station may transmit initialDownlinkBWP and/or initialUplinkBWP which may be included in SIB1, RRC parameter ServingCellConfigCommon, or RRC parameter ServingCellConfig to the UE.

The initialDownlinkBWP may include one, more or all of (I) generic parameters (e.g. locationAndBandwidth, subcarrierSpacing, cyclicPrefix) of the initial Downlink BWP, (II) cell specific parameters (e.g. pdcch-ConfigCommon) for PDCCH of the initial downlink BWP, (III) cell specific parameters (e.g. pdsch-ConfigCommon) for the PDSCH of the initial downlink BWP. The initialUplinkBWP may include one, more or all of (I) generic parameters (e.g. locationAndBandwidth, subcarrierSpacing, cyclicPrefix) of the initial UL BWP, (II) cell specific parameters (e.g. pucch-ConfigCommon) for PUCCH of the initial UL BWP, (III) cell specific parameters (e.g. pusch-ConfigCommon) for the PUSCH of the initial UL BWP, and (IV) cell specific random access parameters (e.g. rach-ConfigCommon).

SIB1, which is a cell-specific system information block (SystemInformationBlock, SIB), may contain information relevant when evaluating if a UE is allowed to access a cell and define the scheduling of other system information. SIB1 may also contain radio resource configuration information that is common for all UEs and barring information applied to the unified access control. The RRC parameter ServingCellConfigCommon is used to configure cell specific parameters of a UE's serving cell. The RRC parameter ServingCellConfig is used to configure (add or modify) the UE with a serving cell, which may be the SpCell or an SCell of an MCS or SCG. The RRC parameter ServingCellConfig herein are mostly UE specific but partly also cell specific.

The base station may configure the UE with a RRC parameter BWP-Downlink and a RRC parameter BWP-Uplink. The RRC parameter BWP-Downlink can be used to configure an additional DL BWP. The RRC parameter BWP-Uplink can be used to configure an additional UL BWP. The base station may transmit the BWP-Downlink and the BWP-Uplink which may be included in RRC parameter ServingCellConfig to the UE.

If a UE is not configured (provided) initialDownlinkBWP from a base station, an initial DL BWP is defined by a location and number of contiguous physical resource blocks (PRBs), starting from a PRB with the lowest index and ending at a PRB with the highest index among PRBs of a CORESET for Type0-PDCCH CSS set (i.e. CORESET #0), and a subcarrier spacing (SCS) and a cyclic prefix for PDCCH reception in the CORESET for Type0-PDCCH CSS set. If a UE is configured (provided) initialDownlinkBWP from a base station, the initial DL BWP is provided by initialDownlinkBWP. If a UE is configured (provided) initialUplinkBWP from a base station, the initial UL BWP is provided by initialUplinkBWP.

The UE may be configured by the based station, at least one initial BWP and up to 4 additional BWP(s). One of the initial BWP and the configured additional BWP(s) may be activated as an active BWP. The UE may monitor DCI format, and/or receive PDSCH in the active DL BWP. The UE may not monitor DCI format, and/or receive PDSCH in a DL BWP other than the active DL BWP. The UE may transmit PUSCH and/or PUCCH in the active UL BWP. The UE may not transmit PUSCH and/or PUCCH in a BWP other than the active UL BWP.

As above-mentioned, a UE may monitor DCI format in the active DL BWP. To be more specific, a UE may monitor a set of PDCCH candidates in one or more CORESETs on the active DL BWP on each activated serving cell configured with PDCCH monitoring according to corresponding search space set where monitoring implies decoding each PDCCH candidate according to the monitored DCI formats.

A set of PDCCH candidates for a UE to monitor is defined in terms of PDCCH search space sets. A search space set can be a CSS set or a USS set. A UE may monitor a set of PDCCH candidates in one or more of the following search space sets
a Type0-PDCCH CSS set configured by pdcch-ConfigSIB1 in MIB or by searchSpaceSIB1 in PDCCH-ConfigCommon or by searchSpaceZero in PDCCH-ConfigCommon for a DCI format with CRC scrambled by a SI-RNTI on the primary cell of the MCG
a Type0A-PDCCH CSS set configured by searchSpaceOtherSystemInformation in PDCCH-ConfigCommon for a DCI format with CRC scrambled by a SI-RNTI on the primary cell of the MCG
a Type1-PDCCH CSS set configured by ra-SearchSpace in PDCCH-ConfigCommon for a DCI format with CRC scrambled by a RA-RNTI or a TC-RNTI on the primary cell
a Type2-PDCCH CSS set configured by pagingSearchSpace in PDCCH-ConfigCommon for a DCI format with CRC scrambled by a P-RNTI on the primary cell of the MCG
a Type3-PDCCH CSS set configured by SearchSpace in PDCCH-Config with searchSpaceType=common for DCI formats with CRC scrambled by INT-RNTI, SFI-RNTI, TPC-PUSCH-RNTI, TPC-PUCCH-RNTI, or TPC-SRS-RNTI and, only for the primary cell, C-RNTI, MCS-C-RNTI, or CS-RNTI(s), and
a USS set configured by SearchSpace in PDCCH-Config with searchSpaceType=ue-Specific for DCI formats with CRC scrambled by C-RNTI, MCS-C-RNTI, SP-CSI-RNTI, or CS-RNTI(s).

For a DL BWP, if a UE is configured (provided) one above-described search space set, the UE may determine PDCCH monitoring occasions for a set of PDCCH candidates of the configured search space set. PDCCH monitoring occasions for monitoring PDCCH candidates of a search space set s is determined according to the search space set s configuration and a CORESET configuration associated with the search space set s. In other words, a UE may monitor a set of PDCCH candidates of the search space set in the determined (configured) PDCCH monitoring occasions in one or more configured control resource sets (CORESETs) according to the corresponding search space set configurations and CORESET configuration. A base station may transmit, to a UE, information to specify one or more CORESET configurations and/or one or more search space configurations. The information may be included in MIB and/or SIBs broadcasted by the base station. The information may be included in RRC configurations or RRC parameters. A base station may broadcast system information such as MIB, SIBs to indicate CORESET configuration(s) or search space configuration(s) to a UE. Or the base station may transmit a RRC message including one or more RRC parameters related to CORESET configuration(s) and/or search space configuration(s) to a UE.

An illustration of search space set configuration is described below.

A base station may transmit a RRC message including one or more RRC parameters related to search space configuration. A base station may determine one or more RRC parameter(s) related to search space configuration for a UE. A UE may receive, from a base station, a RRC message including one or more RRC parameters related to search space configuration. RRC parameter(s) related to search space configuration (e.g. SearchSpace, searchSpaceZero) defines how and where to search for PDCCH candidates. ‘search/monitor for PDCCH candidate for a DCI format’ may also refer to ‘monitor/search for a DCI format’ for short.

For example, a RRC parameter searchSpaceZero is used to configure a common search space 0 of an initial DL BWP. The searchSpaceZero corresponds to 4 bits. The base station may transmit the searchSpaceZero via PBCH (MIB) or ServingCell.

Additionally, a RRC parameter SearchSpace is used to define how/where to search for PDCCH candidates. The RRC parameters search space may include a plurality of RRC parameters as like, searchSpaceId, controlResourceSetId, monitoringSlotPeriodicityAndOffset, duration, monitoringSymbolsWithinSlot, nrofCandidates, searchSpaceType. Some of the above-mentioned RRC parameters may be present or absent in the RRC parameters SearchSpace. Namely, the RRC parameter SearchSpace may include all the above-mentioned RRC parameters. Namely, the RRC parameter SearchSpace may include one or more of the above-mentioned RRC parameters. If some of the parameters are absent in the RRC parameter SearchSpace, the UE 102 may apply a default value for each of those parameters.

Herein, the RRC parameter searchSpaceId is an identity or an index of a search space. The RRC parameter searchSpaceId is used to identify a search space. Or rather, the RRC parameter serchSpaceId provide a search space set index s, 0<=s<40. Then a search space s hereinafter may refer to a search space identified by index s indicated by RRC parameter searchSpaceId. The above-mentioned searchSpaceSIB1, searchSpaceOtherSystemInformation, ra-SearchSpace, and pagingSearchSpace indicate respective index of a search space (i.e. searchSpaceId) so that corresponding search space configuration can be determined. Specifically, the searchSpaceSIB1 indicates an index for the Type0-PDCCH CSS set, i.e., search space ID, for SIBI message. The searchSpaceOtherSystemInformation indicates an index for the Type0A-PDCCH CSS set for other system information, i.e., the system information other than MIB and SIB1. The ra-SearchSpace indicates an index for the Type1-PDCCH CSS set for random access procedure. The pagingSearchSpace indicates an index for the Type2-PDCCH CSS set for paging.

The RRC parameter controlResourceSetId concerns an identity of a CORESET, used to identify a CORESET. The RRC parameter controlResourceSetId indicates an association between the search space s and the CORESET identified by controlResourceSetId. The RRC parameter controlResourceSetId indicates a CORESET applicable for the search space. CORESET p hereinafter may refer to a CORESET identified by index p indicated by RRC parameter controlResourceSetId. Each search space is associated with one CORESET. The RRC parameter monitoringSlotPeriodicityAndOffset is used to indicate slots for PDCCH monitoring configured as periodicity and offset. Specifically, the RRC parameter monitoringSlotPeriodicityAndOffset indicates a PDCCH monitoring periodicity of kₛ slots and a PDCCH monitoring offset of oₛ slots. A UE can determine which slot is configured for PDCCH monitoring according to the RRC parameter monitoringSlotPeriodicityAndOffset. The RRC parameter monitoringSymbolsWithinSlot is used to indicate a first symbol(s) for PDCCH monitoring in the slots configured for PDCCH monitoring. That is, the parameter monitoringSymbolsWithinSlot provides a PDCCH monitoring pattern within a slot, indicating first symbol(s) of the CORESET within a slot (configured slot) for PDCCH monitoring. The RRC parameter duration indicates a number of consecutive slots Ts that the search space lasts (or exists) in every occasion (PDCCH occasion, PDCCH monitoring occasion).

The RRC parameter may include aggregationLevel1, aggregationLevel2, aggregationLevel4, aggregationLevel8, aggregationLevel16. The RRC parameter nrofCandidates may provide a number of PDCCH candidates per CCE aggregation level L aggregationLevel1, by aggregationLevel2, aggregationLevel4, aggregationLevel8, and aggregationLevel16, for CCE aggregation level 1, CCE aggregation level 2, CCE aggregation level 4, for CCE aggregation level 8, and CCE aggregation level 16, respectively. In other words, the value L can be set to either one in the set {1, 2, 4, 8, 16}. The number of PDCCH candidates per CCE aggregation level L can be configured as 0, 1, 2, 3, 4, 5, 6, or 8. For example, in a case the number of PDCCH candidates per CCE aggregation level L is configured as 0, the UE may not search for PDCCH candidates for CCE aggregation L. That is, in this case, the UE may not monitor PDCCH candidates for CCE aggregation L of a search space set s. For example, the number of PDCCH candidates per CCE aggregation level L is configured as 4, the UE may monitor 4 PDCCH candidates for CCE aggregation level L of a search space set s.

The RRC parameter searchSpaceType is used to indicate that the search space set s is either a CSS set or a USS set. The RRC parameter searchSpaceType may include either a common or a ue-Specific. The RRC parameter common configure the search space set s as a CSS set and DCI format to monitor. The RRC parameter ue-Specific configures the search space set s as a USS set. The RRC parameter ue-Specific may include dci-Formats. The RRC parameter dci-Formats indicates to monitor PDCCH candidates either for DCI format 0_0 and DCI format 1_0, or for DCI format 0_1 and DCI format 1_1 in search space set s. That is, the RRC parameter searchSpaceType indicates whether the search space set s is a CSS set or a USS set as well as DCI formats to monitor for. The RRC parameter ue-Specific may further include a new RRC parameter (e.g. dci-FormatsExt) in addition to the dci-Formats. The RRC parameter dci-FormatsExt indicates to monitor PDCCH candidates for DCI format 0_2 and DCI format 1_2, or for DCI format 0_1, DCI format 1_1, DCI format 0_2 and DCI format 1_2. If the RRC parameter dci-FormatsExt is included in the RRC parameter ue-Specific, the UE may ignore the RRC parameter dci-Formats. That is to say, the UE may not monitor the PDCCH candidates for DCI formats indicated by the RRC parameter dci-Format and may monitor the PDCCH candidates for DCI formats indicated by the RRC parameter dci-FormatsExt.

The UE 102 may monitor PDCCH candidates for DCI format 0_0 and/or DCI format 1_0 in either a CSS or a USS. The UE 102 may monitor PDCCH candidates for DCI format 0_1, DCI format 1_1, DCI format 0_2 and/or DCI format 1_2 only in a USS but cannot monitor PDCCH candidates for DCI format 0_1, DCI format 1_1, DCI format 0_2, and/or DCI format 1_2 in a CSS. The DCI format 0_1 may schedule up to two transport blocks for one PUSCH while the DCI format 0_2 may only schedule one transport blocks for one PUSCH. DCI format 0_2 may not consist of some fields (e.g. ‘CBG transmission information’ field), which may be present in DCI format 0_1. Similarly, the DCI format 1_1 may schedule up to two transport blocks for one PDSCH while the DCI format 1_2 may only schedule one transport blocks for one PDSCH. DCI format 1_2 may not consist of some fields (e.g., ‘CBG transmission information’ field), which may be present in DCI format 1_1. The DCI format 1_2 and DCI format 1_1 may consist of one or more same DCI fields (e.g., ‘antenna port’ field).

The base station 160 may schedule a UE 102 to receive PDSCH by a downlink control information (DCI). A DCI format provides DCI and includes one or more DCI fields. The one or more DCI fields in a DCI format are mapped to the information bits. As above-mentioned, the UE 102 can be configured by the base station 160 one or more search space sets to monitor PDCCH for detecting corresponding DCI formats. If the UE 102 detects a DCI format (e.g., the DCI format 1_0, the DCI format 1_1, or the DCI format 1_2) in a PDCCH, the UE 102 may be scheduled by the DCI format to receive a PDSCH.

A USS at CCE aggregation level L is defined by a set of PDCCH candidates for CCE aggregation L. A USS set may be constructed by a plurality of USS(s) corresponding to respective CCE aggregation level L. A USS set may consist of one or more USS(s) corresponding to respective CCE aggregation level L. Likewise, a CSS at CCE aggregation level L is defined by a set of PDCCH candidates for CCE aggregation L. A CSS set may be constructed by a plurality of CSS(s) corresponding to respective CCE aggregation level L. A CSS set may consist of one or more CSS(s) corresponding to respective CCE aggregation level L.

Herein, ‘a UE monitor PDCCH for a search space set s’ also refers to ‘a UE may monitor a set of PDCCH candidates of the search space set s’. Alternatively, ‘a UE monitor PDCCH for a search space set s’ also refers to ‘a UE may attempt to decode each PDCCH candidate of the search space set s according to the monitored DCI formats’. As above-mentioned, the PDCCH is used for transmitting or carrying Downlink Control Information (DCI). Thus, ‘PDCCH’, ‘DCI’, ‘DCI format’, and/or ‘PDCCH candidate’ are virtually interchangeable. In other words, ‘a UE monitors PDCCH’ implies ‘a UE monitors PDCCH for a DCI format’. That is, ‘a UE monitors PDCCH’ implies ‘a UE monitors PDCCH for detection of a configured DCI format’.

In the present disclosure, the term “PDCCH search space sets” may also refer to “PDCCH search space”. A UE monitors PDCCH candidates in one or more of search space sets. A search space sets can be a common search space (CSS) set or a UE-specific search space (USS) set. In some implementations, a CSS set may be shared/configured among multiple UEs. The multiple UEs may search PDCCH candidates in the CSS set. In some implementations, a USS set is configured for a specific UE. The UE may search one or more PDCCH candidates in the USS set. In some implementations, a USS set may be at least derived from a value of C-RNTI addressed to a UE.

An illustration of CORESET configuration is described below.

A base station may configure a UE one or more CORESETs for each DL BWP in a serving cell. For example, a RRC parameter ControlResourceSetZero is used to configure CORESET #0 of an initial DL BWP. The RRC parameter ControlResourceSetZero corresponds to 4 bits. The base station may transmit ControlResourceSetZero, which may be included in MIB or RRC parameter ServingCellConfigCommon, to the UE. MIB may include the system information transmitted on BCH (PBCH). A RRC parameter related to initial DL BWP configuration may also include the RRC parameter ControlResourceSetZero. RRC parameter ServingCellConfigCommon is used to configure cell specific parameters of a UE's serving cell and contains parameters which a UE would typically acquire from SSB, MIB or SIBs when accessing the cell form IDLE. The CORESET #0 refers to a common CORESET with ID #0.

Additionally, a RRC parameter ControlResourceSet is used to configure a time and frequency CORESET other than CORESET #0. The RRC parameter ControlResourceSet may include a plurality of RRC parameters such as, ControlResourceSetId, frequencyDomainResource, duration, cce-REG-MappingType, precoderGranularity, tci-PresentInDCI, pdcch-DMRS-ScramblingID and so on.

Here, the RRC parameter ControlResourceSetId is an CORESET index p, used to identify a CORESET within a serving cell, where 0<p<12. The RRC parameter duration indicates a number of consecutive symbols of the CORESET N_{symb}^{CORESET}, which can be configured as 1, 2 or 3 symbols. A CORESET consists of a set of N_{RB}^{CORESET} resource blocks (RBs) in the frequency domain and N_{symb}^{CORESET} symbols in the time domain. The RRC parameter frequencyDomainResource indicates the set of N_{RB}^{CORESET} RBs for the CORESET. Each bit in the frequencyDomainResource corresponds a group of 6 consecutive RBs, with grouping starting from the first RB group in the BWP. The first (left-most/most significant) bit corresponds to the first RB group in the BWP, and so on. The first common RB of the first RB group has common RB index 6×ceiling (N_{BWP}^{start}/6). A bit that is set to 1 indicates that this RB group belongs to the frequency domain resource of this CORESET. Bits corresponding to a group of RBs not fully contained in the bandwidth part within which the CORESET is configured are set to zero. The ceiling (A) function hereinafter is to output a smallest integer not less than A.

According to the CORESET configuration, a CORESET (a CORESET #0 or a CORESET p) consists of a set of PRBs with a time duration of 1 to 3 OFDM symbols. The resource units Resource Element Groups (REGs) and Control Channel Elements (CCEs) are defined within a CORESET. A CCE consists of 6 REGs where a REG equals one resource block during one OFDM symbol. Control channels are formed by aggregation of CCE. That is, a PDCCH consists of one or more CCEs. Different code rates for the control channels are realized by aggregating different number of CCE. Interleaved and non-interleaved CCE-to-REG mapping are supported in a CORESET. Each resource element group carrying PDCCH carries its own DMRS.

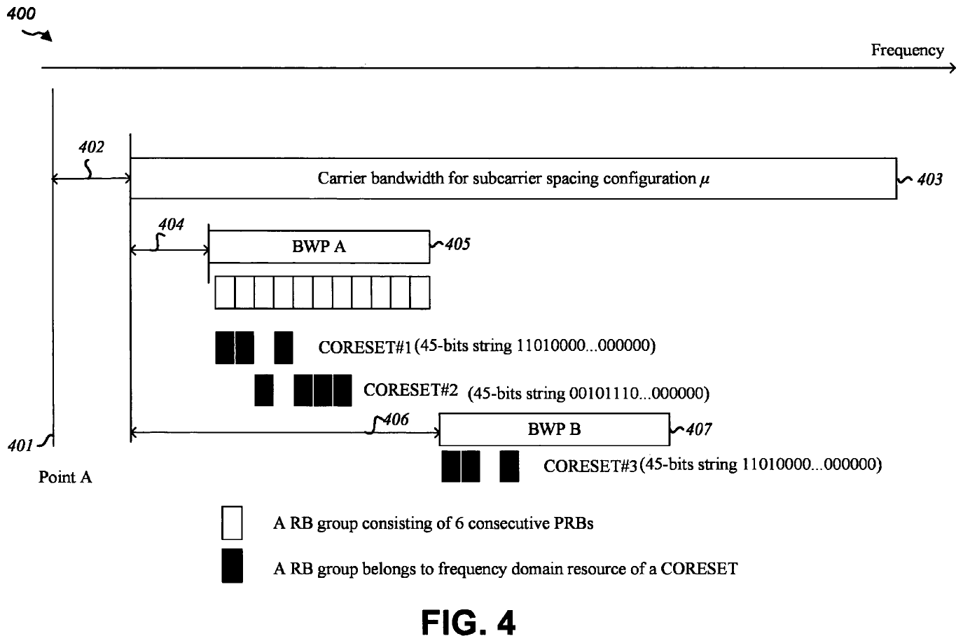

FIG. 4 is a diagram illustrating one 400 example of CORESET configuration in a BWP by a UE 102 and a base station 160.

FIG. 4 illustrates that a UE 102 is configured with three CORESETs for receiving PDCCH transmission in two BWPs. In the FIG. 4, 401 represent point A. 402 is an offset in frequency domain between point A 401 and a lowest usable subcarrier on the carrier 403 in number of CRBs, and the offset 402 is given by the offsetToCarrier in the SCS-SpecificCarrier IE. The BWP 405 with index A and the carrier 403 are for a same subcarrier spacing configuration μ. The offset 404 between the lowest CRB of the carrier and the lowest CRB of the BWP in number of RBs is given by the locationAndBandwidth included in the BWP configuration for BWP A. The BWP 407 with index B and the carrier 403 are for a same subcarrier spacing configuration μ. The offset 406 between the lowest CRB of the carrier and the lowest CRB of the BWP in number of RBs is given by the locationAndBandwidth included in the BWP configuration for BWP B.

For the BWP 405, two CORESETs are configured. As above-mentioned, a RRC parameter frequencyDomainResource in respective CORESET configuration indicates the frequency domain resource for respective CORESET. In the frequency domain, a CORESET is defined in multiples of RB groups and each RB group consists of 6 RBs. For example, in the FIG. 4, the RRC parameter frequencyDomainResource provides a bit string with a fixed size (e.g. 45 bits) as like ‘11010000 . . . 000000’ for CORESET #1. That is, the first RB group, the second RB group, and the fourth RB group belong to the frequency domain resource of the CORESET #1. Additionally, the RRC parameter frequencyDomainResource provides a bit string with a fixed size (e.g. 45 bits) as like ‘00101110 . . . 000000’ for CORESET #2. That is, the third RB group, the fifth RB group, the sixth RB group and the seventh RB group belong to the frequency domain resource of the CORESET #2.

For the BWP 407, one CORESET is configured. As above-mentioned, a RRC parameter frequencyDomainResource in the CORESET configuration indicates the frequency domain resource for the CORESET #3. In the frequency domain, a CORESET is defined in multiples of RB groups and each RB group consists of 6 RBs. For example, in the FIG. 4, the RRC parameter frequencyDomainResource provides a bit string with a fixed size (e.g. 45 bits) as like ‘11010000 . . . 000000’ for CORESET #3. That is, the first RB group, the second RB group, and the fourth RB group belong to the frequency domain resource of the CORESET #3. Although the bit string configured for CORESET #3 is same as that for CORESET #1, the first RB group of the BWP B is different from that of the BWP A in the carrier. Therefore, the frequency domain resource of the CORESET #3 in the carrier is different from that of the CORESET #1 as well.

Here, in a CORESET associated with a search space set s, a set of CCEs for AL L are those determining CCE indexes where the PDCCH candidates, the UE 102 is configured to monitor for AL L of the search space set, are placed. Here, a set of CCEs for AL L can also refer to a USS. That is, a search space set s may comprise of one or more corresponding sets of CCEs for respective AL L. A set of CCEs can also refer to as ‘a USS’. A set of CCEs for AL L can also refer to ‘a USS at AL L’.

As above-mentioned, the UE 102 may receive, from the base station 160, a RRC message including one or more RRC parameters related to search space configuration. The UE 102 may determine PDCCH monitoring occasions for PDCCH candidates for each search space set s based on the received the RRC parameters. The UE 102 may monitor PDCCH candidates for each search space set s in the determined PDCCH monitoring occasions. For example, a RRC parameter (e.g. SearchSpace) may provide the UE 102 for a search space set s, that a PDCCH monitoring periodicity of kₛ slots, a PDCCH monitoring offset of oₛ slots, a duration of Tₛ, a PDCCH monitoring pattern within a slot, and so on.

A slot format includes downlink symbols, uplink symbols, and the flexible symbols. In other words, OFDM symbols in a slot can be classified as ‘downlink’, ‘flexible’, or ‘uplink’. For each serving cell, the UE 102 may be provided a RRC parameter (e.g., a cell specific RRC parameter tdd-UL-DL-ConfigurationCommon, cell specific TDD UL/DL configuration). The UE 102 may set the slot format per slot over a number of slots based on the RRC parameter tdd-UL-DL-ConfigurationCommon. That is, the RRC parameter tdd-UL-DL-ConfigurationCommon is used to determine the cell specific TDD Uplink/Downlink (UL/DL) configuration. In the present disclosure, ‘cell specific TDD UL/DL configuration’ and ‘RRC parameter tdd-UL-DL-ConfigurationCommon’ can be used interchangeably.

In the present disclosure, the UE 102 may receive, from the base station, the cell specific TDD UL/DL configuration. The UE 102 may set the slot format per slot over a number of slots as indicated by the cell specific TDD UL/DL configuration. A slot includes downlink symbols, uplink symbols, and flexible symbols. In other words, setting slot format for a slot means determining each symbol in the slot where the symbol is downlink symbol, uplink symbol, or flexible symbol. Specifically, the cell-specific TDD UL/DL configuration may include a RRC parameter referenceSubcarrierSpacing and a RRC parameter pattern1. The RRC parameter referenceSubcarrierSpacing is used to indicate a SCS configuration (a reference SCS configuration). The SCS configuration (the reference SCS configuration) can be denoted as u_{ref}. The RRC parameter pattern1 may provide a slot configuration period of P msec by dl-UL-TransmissionPeriodicity, a number of slots dₛₗₒₜₛ with only downlink symbols by nrofDownlinkSlots, a number of downlink symbols d_{sym} by nrofDownlinkSymbols, a number of slots uₛₗₒₜₛ with only uplink symbols by nrofUplinkSlots, and a number of uplink symbols u_{sym} by nrofUplinkSymbols.

A slot with only downlink symbols means all symbols in the slot are indicated as downlink by the cell specific TDD UL/DL configuration. Likewise, a slot with only uplink symbols means all symbols in the slot are indicated as uplink by the cell specific TDD UL/DL configuration. A slot with only downlink symbols can be termed a downlink slot. A slot with only uplink symbols can be termed an uplink slot. A slot with only flexible symbols can be termed a flexible slot.

The UE 102 (e.g., control unit of the UE) may use the SCS configuration u_{ref} provided in the cell-specific TDD UL/DL configuration to determine a number of slot within the period of P msec. The UE 102 may determine that the period of P msec includes S=P*2^{uref} slots with the SCS configuration u_{ref}. The UE 102 may set, based on the cell-specific TDD UL/DL configuration, slot format per slot over a first number of slots. A first number of slots herein refers to the S=P*2^{uref} slots with the SCS configuration u_{ref}. That is, for S slots, the UE 102 may determine, based on the cell-specific TDD UL/DL configuration, which slots are downlink slots, which slots are uplink slots, which symbols are downlink symbols, which symbols are flexible symbols, and/or which symbols are uplink symbols.

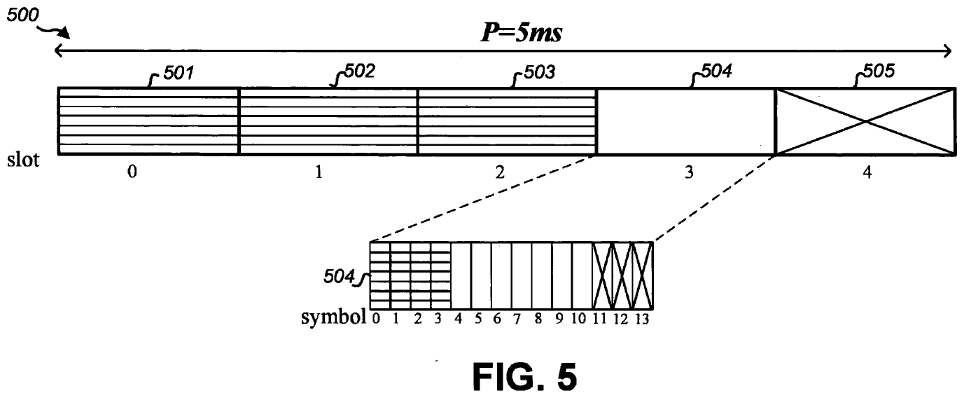

FIG. 5 is a diagram illustrating one example 500 of cell specific TDD UL/DL configuration. In the FIG. 5, the cell specific TDD UL/DL configuration provides the UE 102 that the value of u_{ref} is 0, i.e., 15 kHz, the value of P is 5 msec, the value of dₛₗₒₜₛ is 3, the value of d_{sym} is 4, the value of uₛₗₒₜₛ is 1, and the value of u_{sym} is 3.

As shown in the FIG. 5, the slot configuration period of P=5 msec includes S=P*2^{uref}=5*2⁰=5 slots. From the S=5 slots, a first dₛₗₒₜₛ=3 slots (i.e., slot 501, slot 502, and slot 503) include only downlink symbols and a last uₛₗₒₜₛ=1 slot (i.e., slot 505) includes only uplink symbols. The d_{sym} symbols after the first dₛₗₒₜₛ slots are downlink symbols and the u_{sym} symbols before the last uₛₗₒₜₛ slots are uplink symbols. The remaining (S−dₛₗₒₜₛ−uₛₗₒₜₛ)*N_{symb}^{slot}−d_{sym}−u_{sym} are flexible symbols. N_{symb}^{slot} is a number of symbols in a slot. A number of symbols in a slot for normal cyclic prefix is different from that in a slot for extended cyclic prefix. For normal cyclic prefix, the value of N_{symb}^{slot} is 14 symbols. For extended cyclic prefix, the value of N_{symb}^{slot} is 12 symbols. Here, 14 symbols are used as the value of N_{symb}^{slot} to determine/calculate the remaining symbols. In the FIG. 5, the first d_{sym}=4 symbols of the slot 504 are downlink symbols. The last u_{sym}=3 symbols of the slot 504 are uplink symbols. And the remaining 7 symbols in the slot 504 are flexible symbols.

The UE 102 may be additionally provided a RRC parameter (e.g., a UE-specific RRC parameter tdd-UL-DL-ConfigurationDedicated). The RRC parameter tdd-UL-DL-ConfigurationDedicated is used to determine the UE-specific Uplink/Downlink TDD configuration. The UE 102 may use tdd-UL-DL-ConfigurationDedicated to override the only flexible symbols per slot over the number of slots as provided by tdd-UL-DL-ConfigurationCommon. To be more specific, for the flexible symbols provided by the tdd-UL-DL-ConfigurationCommon, the UE 102 may further determine these flexible symbols as downlink or uplink based on the tdd-UL-DL-ConfigurationDedicated. Alternatively, for the flexible symbols provided by the tdd-UL-DL-ConfigurationCommon, the UE 102 may not further determine these flexible symbols as downlink or uplink based on the tdd-UL-DL-ConfigurationDedicated. In other words, for the flexible symbols provided by the tdd-UL-DL-ConfigurationCommon but not determined as downlink or uplink based on the tdd-UL-DL-ConfigurationDedicated, the UE 102 may still determine these flexible symbols as flexible (flexible symbols).

In the present disclosure, ‘slot format determined based on the tdd-UL-DL-ConfigurationCommon and/or the tdd-UL-DL-ConfigurationDedicated’ can also refer to as ‘slot format determined based on RRC parameter(s)’. The slot format configuration provided by the tdd-UL-DL-ConfigurationCommon and/or the tdd-UL-DL-ConfigurationDedicated′ can be regarded as the higher layer slot format configuration (or higher layer slot format configuration information).

In the present disclosure, besides transmitting the RRC parameters to indicate the slot format (or slot configuration), the base station 160 also may transmit, to the UE 102, a DCI format (e.g. DCI format 2_0) to set the slot format for one or more slots. The DCI format 2_0 includes one or more slot format indicator fields. Each slot format indicator field can provide a slot format value. The slot format value in a DCI format 2_0 indicates to a UE a slot format for each slot in a number of slots for each DL BWP or each UL BWP starting from a slot where the UE 102 detects the DCI format 2_0. The UE 102 may detect a DCI format 2_0 and set a slot format for each slot by using the corresponding slot format value(s) indicated by the DCI format 2_0. Slot format can be provided by a predefined slot format table.

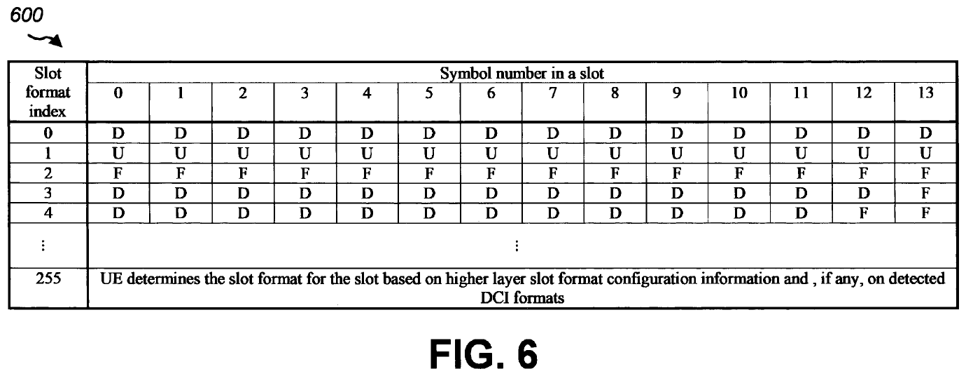

FIG. 6 is a diagram illustrating one example 600 of a slot format table. A slot format is identified by a corresponding slot format value (or slot format index) as provided in the FIG. 6 where ‘D’ denotes a downlink symbol, ‘U’ denotes an uplink symbols, and ‘F’ denotes a flexible symbols. For each slot format, ‘symbol number in a slot’ corresponds to a symbol whose index is from 0 to 13 in a slot. For example, the UE 102 may detect a DCI format 2_0 with a slot format value. Then, by referring to FIG. 6, the UE 102 can set a slot format with the corresponding slot format value for a slot. As shown in FIG. 6, a slot format value with 255 does not directly indicate a specified slot format for a slot. That is, in a case where the UE 102 detects a DCI format 2_0 with a slot format value with 255, the UE 102 may determine slot format for a slot based on the higher layer slot format configuration.

For a set of symbols of a slot that are indicated as downlink/uplink by the tdd-UL-DL-ConfigurationCommon, and/or the tdd-UL-DL-ConfigurationDedicated, the UE 102 may not detect a DCI format with a slot format value indicating the set of symbols as uplink/downlink, respectively, or as flexible. In other words, only for a set of symbols of a slot that are indicated as flexible by tdd-UL-DL-ConfigurationCommon, and/or the tdd-UL-DL-ConfigurationDedicated, the UE 102 may detect a DCI format with a slot format value indicating the set of symbols as downlink, uplink, or flexible. That is, the UE 102 may use a slot format value indicated by a DCI format 2_0 to override the only flexible symbols of a slot provided by tdd-UL-DL-ConfigurationCommon, and/or the tdd-UL-DL-ConfigurationDedicated. The UE 102 may determine (or set) a set of flexible symbols of a slot provided by tdd-UL-DL-ConfigurationCommon, and/or the tdd-UL-DL-ConfigurationDedicated as downlink, uplink, or flexible.

Additionally or alternatively, a UE 102 may not be configured by the base station 160 to monitor PDCCH for DCI format 2_0 on a serving cell. In this case, the UE 102 may determine the slot format per slot over a number of slots as indicated by the tdd-UL-DL-ConfigurationCommon, and/or the tdd-UL-DL-ConfigurationDedicated. In the present disclosure, for a slot, the slot format is determined based on the RRC parameters (e.g. tdd-UL-DL-ConfigurationCommon, and/or the tdd-UL-DL-ConfigurationDedicated) and/or the DCI format (e.g. the DCI format 2_0).

As above-mentioned, in a TDD carrier, the time domain resource is split between downlink, flexible and uplink. Therefore, the contiguous time domain resource used for uplink in TDD carrier is a limited time duration, which results in reduced coverage, increased latency and reduced capacity. Therefore, at least from the perspective of uplink coverage, latency and capacity, contiguous resources in time domain and/or frequency domain for UL transmission is beneficial. One feasible way is to allow to configure an UL transmission region in the symbols that are indicated as downlink and/or flexible. That is, in the present disclosure, simultaneous existence of downlink and uplink in slots and symbols indicated as downlink and/or flexible by the cell specific TDD UL/DL configuration can be allowed.

A plurality of UEs may operate in a same TDD carrier. These UEs may operate in same or different BWPs with different frequency ranges and locations in the carrier. To avoid interference between DL transmission and UL transmission from different UEs and/or base stations, this kind of time and frequency resources of a UL transmission region should be common resources to UEs and/or base stations operating in the carrier (or cell).

Furthermore, different BWPs may be configured by the base station with different subcarrier spacing configurations. In other words, for a same TDD carrier, different subcarrier spacing configurations can be configured for a same carrier or a same cell. The frequency bandwidth of 1 RB (CRB, PRB) depends on subcarrier spacing configuration. The time duration of 1 symbol or 1 slot depends on subcarrier spacing configuration as well. For example, for subcarrier spacing configuration with 15 kHz, 30 kHz, 60 kHz, and 120 kHz, 1 PRB bandwidth corresponds to 180 kHz, 360 kHz, 720 kHz, and 1440 kHz, while 1 slot duration corresponds to 1 ms, 0.5 ms, 0.25 ms, and 0.125 ms. In other words, a slot with respect to different subcarrier spacing configurations may occupy different time durations. For different subcarrier spacing configurations, the number of slots per subframe (1 ms) or per frame (10 ms) are also different. Likewise, 1 RB with respect to different subcarrier spacing configurations may occupy different frequency bandwidth (frequency range).

Therefore, without determining a subcarrier spacing configuration, it is not possible for UEs and/or base station to determine specific time and frequency locations and ranges (durations) even if a number of slots and a number of RBs are indicated.

In the present disclosure, indication for time-frequency resources of the UL transmission region and determination of subcarrier spacing configuration for the UL transmission region are provided, which ensure UEs and/or base stations operating in a same carrier (cell) to have a same understanding on how the time-frequency resources of the UL transmission region are indicated (or determined) and how the subcarrier spacing configuration used for the UL transmission region is determined. According to the present disclosure, a more efficient and flexible communication between UEs and/or base stations is provided.

As above-mentioned, UL transmission region (sub-band) may be configured in downlink symbols and/or flexible symbols indicated by the cell-specific TDD UL/DL configuration. UE 102 may perform UL transmission in the UL transmission region and may not perform DL reception in the UL transmission region. The UE 102 may perform DL reception in frequency range(s) outside the UL transmission region. An UL transmission region may include a time-frequency resource. The time resource may include zero, one or more contiguous or noncontiguous slots and/or zero, one or more contiguous or noncontiguous symbols. Symbols of a UL transmission region may exclude symbols for reception of SS/PBCH blocks. The frequency resource may include one or more contiguous resource blocks. In other others, an UL transmission region may be defined as one or more contiguous RBs in frequency domain and one or more contiguous (or non-contiguous) symbols in time domain. An UL transmission region configures a reference time and frequency region where UL transmission is applicable in symbol(s) that are indicated as downlink by the cell specific TDD UL/DL configuration.

In the present disclosure, in a time duration within which symbols and/or slot(s) are indicated as downlink and/or flexible by the cell-specific TDD UL/DL configuration, the UE 102 can be configured an UL transmission region for uplink transmission by the base station. An UL transmission region may also refer to a UL sub-band (a subset of band for UL transmission, a UL frequency region, or a resource set) that are configured in or located in symbols or slots indicated as downlink or flexible by the cell-specific TDD UL/DL configuration.

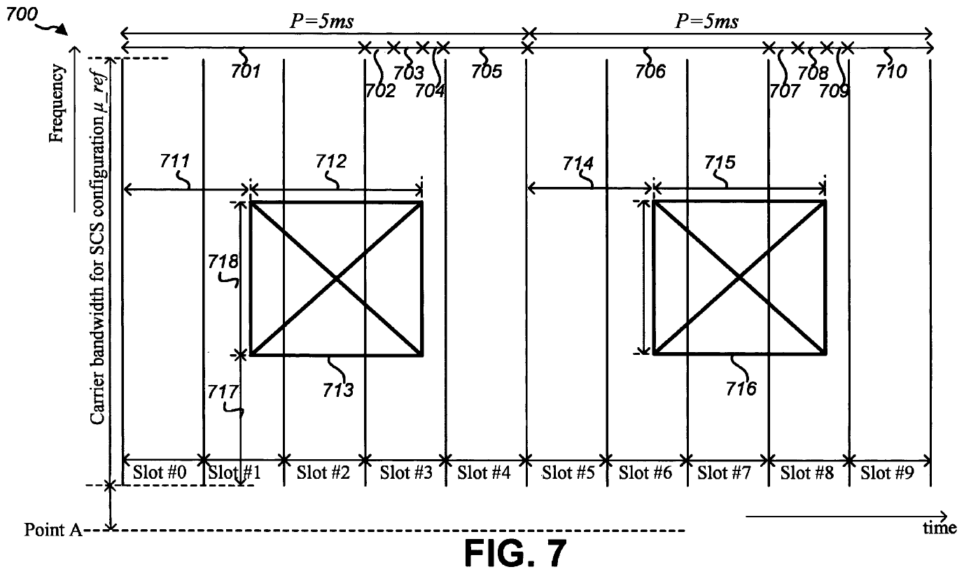

FIG. 7 is a diagram illustrating one implementation of a method 700 how to determine subcarrier spacing and time-frequency resources for an UL transmission region by a UE 102 and a base station 160. In the implementation of the present disclosure, subcarrier spacing configuration for an UL transmission region is determined and the time-frequency resources is determined based on the determined subcarrier spacing configuration.

The base station 160 may transmit, to the UE 102, a cell-specific TDD UL/DL configuration (e.g. tdd-UL-DL-ConfigurationCommon) to indicate slot format per slot over a number of slots. The UE 102 may receive from the base station 160, the cell-specific TDD UL/DL configuration. The UE 102 may set slot format per slot over a number of slots as indicted by the cell-specific TDD UL/DL configuration. As above-mentioned, the number of slots is determined as S=P*2^{uref} slots with the subcarrier spacing configuration u_{ref}. For simplicity, information provided by the cell specific TDD UL/DL configuration in the FIG. 7 is same as information provided by the cell specific TDD UL/DL configuration in the FIG. 5. For example, in the FIG. 7, the cell specific TDD UL/DL configuration provides the UE 102 that the value of u_{ref} is 0, i.e., 15 kHz, the value of P is 5 msec, the value of dₛₗₒₜₛ is 3, the value of d_{sym} is 4, the value of uₛₗₒₜₛ is 1, and the value of u_{sym} is 3.

As above-mentioned, a symbol duration or a slot duration in the time domain depends on its associated or defined subcarrier spacing configuration. The cell-specific TDD UL/DL configuration includes an RRC parameter providing or indicating the subcarrier spacing configuration u_{ref}. The UE 102 and/or the base station 160 may use the subcarrier spacing configuration u_{ref} provided by the cell-specific TDD UL/DL configuration to determine slots and/or symbols during a slot configuration period P.

The UE 102 and/or the base station 160 may use the subcarrier spacing configuration u_{ref} provided by the cell-specific TDD UL/DL configuration to set slot format per slot over a number of slots during the slot configuration period P. Each symbol with the subcarrier spacing configuration u_{ref} is indicated as downlink symbol, flexible symbol, or uplink symbol by the cell-specific TDD UL/DL configuration. In other words, the base station 160 and the UE 102 may use the subcarrier spacing configuration provided in the cell-specific TDD UL/DL configuration to determine symbols in each slot of the slot configuration period as downlink, flexible, or uplink over the S=P*2^{uref} slots as indicated by the cell-specific TDD UL/DL configuration.

In the FIG. 7, each slot configuration period of P=5 msec includes S=P*2^{uref}=5*2⁰=5 slots depending on the u_{ref}. Slot values dₛₗₒₜₛ and uₛₗₒₜₛ, and, symbol values d_{sym} and u_{sym} are associated to or defined by the u_{ref}. From the S=5 slots included in the first period P, the time duration 701 includes a first dₛₗₒₜₛ=3 slots (i.e., slot #0, slot #1, and slot #2) for u_{ref}=0 and the time duration 705 includes a last uₛₗₒₜₛ=1 slot (i.e., slot #4) for u_{ref}=0. The time duration 702 includes a d_{sym}=4 downlink symbols in the slot #3 for u_{ref}=0 and the time duration 704 includes the u_{sym}=3 uplink symbols in the slot #3 for u_{ref}=0. The time duration 703 includes the remaining (S−dₛₗₒₜₛ−uₛₗₒₜₛ)*N_{symb}^{slot}−d_{sym}−u_{sym}=7 flexible symbols u_{ref}=0. Similarly, from the S=5 slots included in the second period P, the time duration 706 includes a first dₛₗₒₜₛ=3 slots (i.e., slot #5, slot #6, and slot #7) for u_{ref}=0 and the time duration 710 includes a last uₛₗₒₜₛ=1 slot (i.e., slot #9) for u_{ref}=0. The time duration 707 includes a d_{sym}=4 downlink symbols in the slot #8 for u_{ref}=0 and the time duration 709 includes the u_{sym}=3 uplink symbols in the slot #8 for u_{ref}=0. The time duration 708 includes the remaining (S−dₛₗₒₜₛ−uₛₗₒₜₛ)*N_{symb}^{slot}−d_{sym}−u_{sym}=7 flexible symbols for u_{ref}=0.

The base station 160 may transmit, to the UE 102, a configuration of an UL transmission region. The UE 102 may receive, from the base station 160, the configuration of the UL transmission region. Upon the reception of the configuration of UL transmission region, the UE 102 is provided the configuration of UL transmission region. If UE 102 is provided the configuration of UL transmission region, the UE 102 may determine subcarrier spacing, time and frequency resource for the UL transmission region. In the FIG. 7, the block 713 with cross mark is a UL transmission region in the first period P and the block 716 with cross mark is a UL transmission region in the second period P.

The configuration of the UL transmission region may include or provide an indication (or resource configuration) for time-frequency resource of the UL transmission region. The indication may include a first information (or a first indication) related to time resource of the UL transmission region and a second information (or a second indication) related to frequency resource of the UL transmission region. The first information may configure time region of the UL transmission region, while the second information may configure frequency region of the UL transmission region.

The first information may provide a time offset and a time duration of the time region for the UL transmission region. The second information may provide a frequency offset and a frequency bandwidth of the frequency region for the UL transmission region. How to determine time resource (time region) and frequency resource (frequency region) for the UL transmission region is described later.

As above-mentioned, time duration of a slot or a symbol varies depending on different subcarrier spacing configurations. And frequency bandwidth of 1 RB varies depending on different subcarrier spacing configurations. A symbol duration or a slot duration in the time domain depends on its associated or defined subcarrier spacing configuration. Likewise, an RB bandwidth in the frequency domain depends on its associated or defined subcarrier spacing configuration.

In order to determine the time-frequency resource of an UL transmission region, the UE 102 and/or the base station 160 may need to first determine a subcarrier spacing configuration for the UL transmission region. Without determining a subcarrier spacing configuration for the UL transmission region, the specific time-frequency resource of the UL transmission region cannot be identified by the UE 102 or the base station 160. For example, if the UE 102 and/or the base station 160 use different subcarrier spacing configurations for the UL transmission region, different time locations/durations and different frequency locations/bandwidths would be determined for the UL transmission region by the UE 102 and/or the base station 160.

In an example A of the implementation of the present disclosure, the UE 102 and/or the base station may determine that the subcarrier spacing configuration provided by the cell-specific TDD UL/DL configuration is the subcarrier spacing configuration for the UL transmission region. That is, the determined subcarrier spacing configuration for the UL transmission region is the subcarrier spacing configuration provided by the cell-specific TDD UL/DL configuration u_{ref}. In the example A, the base station may not generate a parameter B indicating or providing a subcarrier spacing configuration for the UL transmission region to be included in the configuration of the UL transmission region. In this case (i.e., the configuration of the UL transmission region does not include the parameter B), the UE 102 and/or the base station may determine that the subcarrier spacing configuration provided by the cell-specific TDD UL/DL configuration is the subcarrier spacing configuration for the UL transmission region.

Additionally or alternatively, in another example B of the implementation, the configuration may provide a subcarrier spacing configuration for the UL transmission region. In the example B, the base station may generate a parameter B indicating or providing a subcarrier spacing configuration for the UL transmission region wherein the parameter is included in the configuration of the UL transmission region. In this case (i.e., the configuration of the UL transmission region includes the parameter B), the UE 102 and/or the base station may determine that the subcarrier spacing configuration provided by the parameter B is the subcarrier spacing configuration for the UL transmission region. That is, the determined subcarrier spacing configuration for the UL transmission region is the subcarrier spacing configuration provided by the RRC parameter B included in the configuration of the UL transmission region.

Additionally or alternatively, in another example C of the implementation, the configuration may provide a subcarrier spacing configuration for the frequency region of the UL transmission region. In other words, the configuration of the UL transmission region may not provide a subcarrier spacing configuration for the time region of the UL transmission region. In the example C, the base station may generate a parameter C indicating or providing a subcarrier spacing configuration for the frequency region of the UL transmission region wherein the parameter is included in the configuration of the UL transmission region. In this case, the UE 102 and/or the base station may determine that the subcarrier spacing configuration provided by the parameter C is the subcarrier spacing configuration for the frequency region of the UL transmission region. While the UE 102 and/or the base station may determine that the subcarrier spacing configuration provided by the cell-specific TDD UL/DL configuration is the subcarrier spacing configuration for the time region of the UL transmission region. That is, for the UE 102 and/or the base station 160, the determined subcarrier spacing configuration for the frequency region of the UL transmission region is the subcarrier spacing configuration provided by the RRC parameter C included in the configuration of the UL transmission region, and the determined subcarrier spacing configuration for the time region of the UL transmission region is the subcarrier spacing configuration provided by the cell-specific TDD UL/DL configuration.

Then, according to the determined subcarrier spacing configuration as illustrated above, UE 102 and/or the base station 160 may determine the time-frequency region for the UL transmission region. To be specific, the UE 102 and/or the base station 160 may use the determined subcarrier spacing configuration to determine the time resource (time region) of the UL transmission region. The UE 102 and/or the base station 160 may use the determined subcarrier spacing configuration to determine the frequency resource (frequency region) of the UL transmission region.

In the present disclosure, determination of the time resource includes the determination of time location and the determination of time duration for the UL transmission region. The first information may provide a time offset value and time duration value. The time offset may be used to determine the time location (i.e. the starting position in the time domain) of the UL transmission region. The time duration value may be used to determine the time duration of the UL transmission region.

The time offset is an offset from the start of period P to the start of the UL transmission region. The UE 102 and/or the base station 160 may use the determined subcarrier spacing configuration to determine the time offset. The time offset may be a symbol level offset, that is, the time offset value is given in unit of symbols. The time offset value is defined with respect to or is associated to the determined subcarrier spacing configuration. An RRC parameter included in the configuration of UL transmission region may indicate the symbol level offset in units of symbols from a starting symbol of S slots in the period P to the starting symbol of the UL transmission region. In the FIG. 7, the time offset 711 is a symbol level value indicated by an RRC parameter included in the configuration of the UL transmission region. The UE 102 and/or the base station 160 may use the determined subcarrier spacing configuration to determine the time offset based on the symbol level value. For example, the time offset value may be indicated as 20. The symbol interval between the starting symbol of the slot #0 (first symbol of the period P) and the starting symbol of the UL transmission region is 20 symbols with respect to the determined subcarrier spacing configuration.

The time duration is a duration from the start symbol of the UL transmission region to the end symbol of the UL transmission region. The UE 102 and/or the base station 160 may use the determined subcarrier spacing configuration to determine the time duration. The time duration may be a symbol level duration, that is, the time duration value is given in unit of symbols. The time duration value is defined with respect to or is associated to the determined subcarrier spacing configuration. An RRC parameter included in the configuration of UL transmission region may indicate the symbol level duration in units of symbols from a starting symbol of the UL transmission region to the ending symbol of the UL transmission region. In other words, the time duration of the UL transmission region is a set of symbol defined by using the determined subcarrier spacing configuration. The UE 102 and/or the base station 160 may use the determined subcarrier spacing configuration to determine the time duration of the UL transmission region. In the FIG. 7, the time duration 712 is a set of symbols for the UL transmission region 713. The UL transmission region 713 in the time domain is configured in symbols indicated as downlink or flexible symbols by the cell-specific TDD UL/DL configuration. In other words, the UL transmission region 713 in the time domain may not be configured in symbols indicated as uplink symbols by the cell-specific TDD UL/DL configuration. The symbols of the UL transmission region may not include symbols that are used for reception of SS/PBCH blocks. In other words, in a case that the time duration 712 includes symbols used for reception of SS/PBCH blocks, the symbols used for reception of SS/PBCH blocks may be excluded from the time resource of the UL transmission region.

In the present disclosure, determination of the frequency resource includes the determination of frequency location and the determination of frequency bandwidth for the UL transmission region. The second information may provide a frequency offset value and frequency bandwidth value. The frequency offset may be used to determine the frequency location (i.e. the starting position in the frequency domain) of the UL transmission region. The frequency bandwidth value may be used to determine the frequency bandwidth of the UL transmission region.

The frequency offset is an offset from a position A to a start position of the UL transmission region in the frequency domain. The UE 102 and/or the base station 160 may use the determined subcarrier spacing configuration to determine the frequency offset. The frequency offset may be an RB level offset, that is, the frequency offset value is given in unit of RBs. The frequency offset value is defined with respect to the determined subcarrier spacing configuration. The frequency offset value may be indicated by an RRC parameter included in the configuration of UL transmission region. The frequency offset value is defined with respect to the determined subcarrier spacing in unit of resource block. In other words, the frequency offset value is defined for the determined subcarrier spacing in unit of RBs.

In other words, the frequency offset is an RB level offset in units of RBs from a position A (a position of an RB #A) to the first (starting) RB of the UL transmission region. In the frequency domain, the frequency offset can be denoted as RB_{offset}. The RB #A may refer to a starting common RB of a resource grid with respect to the determined subcarrier spacing configuration. In the FIG. 7, the frequency offset 717 is an RB offset from a starting common RB of a resource grid with respect to the determined subcarrier spacing configuration to a starting common RB of the UL transmission region 713 with respect to the determined subcarrier spacing configuration.

As above-mentioned, a starting common RB of a resource grid (i.e., starting position N_{grid}^{start,μ}) for the determined subcarrier spacing configuration is given by the higher-layer parameter offsetToCarrier in the SCS-SpecificCarrier IE corresponding to the determined subcarrier spacing configuration. Therefore, depending on the determined subcarrier spacing configuration, the starting RB index of the UL transmission region can be calculated as O_{carrier}+RB_{offset}. The starting RB index of the UL transmission region means an RB index of a common RB where the UL transmission region starts relative to CRB #0 with respective to the determined subcarrier spacing configuration.

Additionally or alternatively, the RB #A may refer to a common resource block with index 0 with respect to the determined subcarrier spacing configuration. In this case, the starting RB index of the UL transmission region is calculated as RB_{offset}. The starting RB index of the UL transmission region means an RB index of a common RB where the UL transmission region starts relative to CRB #0 with respective to the determined subcarrier spacing configuration.

The frequency bandwidth means a bandwidth from the starting (first) RB of the UL transmission region to the ending (last) RB of the UL transmission region. The UE 102 and/or the base station 160 may use the determined subcarrier spacing configuration to determine the frequency bandwidth. The frequency bandwidth may be a set of contiguous RBs, that is, the frequency bandwidth value is given in unit of RBs. The frequency bandwidth value is defined with respect to or is associated to the determined subcarrier spacing configuration. As in the FIG. 7, the frequency bandwidth 718 is a set of contiguous RBs for the UL transmission region 713. The (total) number of contiguous RBs corresponds to the frequency bandwidth of the UL transmission region.

Then, depending on the determined subcarrier spacing configuration, the UE 102 and/or the base station 160 may determine the time location and time duration of the UL transmission region by the first information. Likewise, depending on the determined subcarrier spacing configuration, the UE 102 and/or the base station 160 may determine the frequency location and bandwidth of the UL transmission region by the second information.

As above-mentioned, the UE 102 may perform UL transmission in an active UL BWP. The active UL BWP may be configured with a different subcarrier spacing configuration from the determined subcarrier spacing configuration for the UL transmission region. The UE may need to determine an actual number of symbols, slots, and/or, RBs for the UL transmission region in the active UL BWP. For convenience, the subcarrier spacing configuration of the active UL BWP is denoted as u_{UL_BWP} and the determined subcarrier spacing configuration for the UL transmission region is denoted as u_{ref}. Each slot or each symbol in the UL transmission region with respect to the u_{ref} is determined as 2^{(uUL_BWP-uref)} consecutive slot(s) or 2^{(uUL_BWP-uref)} consecutive symbol(s) in the active UL BWP with respect to the u_{UL_BWP}. That is, the actual number of slots or symbols of the UL transmission region with respect to the u_{UL_BWP} is determined as the reference number of slots or symbols multiplied by 2^{(uUL_BWP-uref)}. The reference number of slots or symbols are the slots or symbols of the UL transmission region with respect to the u_{ref}. Likewise, each RB in the UL transmission region with respect to the u_{ref} is determined as 2^{(uUL_BWP-uref)} consecutive RB(s) in the active UL BWP with respect to the uUL_BWP. That is, the actual number of RBS of the UL transmission region with respect to the u_{UL_BWP} is determined as the reference number of RBs multiplied by 2^{(uUL_BWP-uref)}. The reference number of RBs are the RBs of the UL transmission region with respect to the u_{ref}.

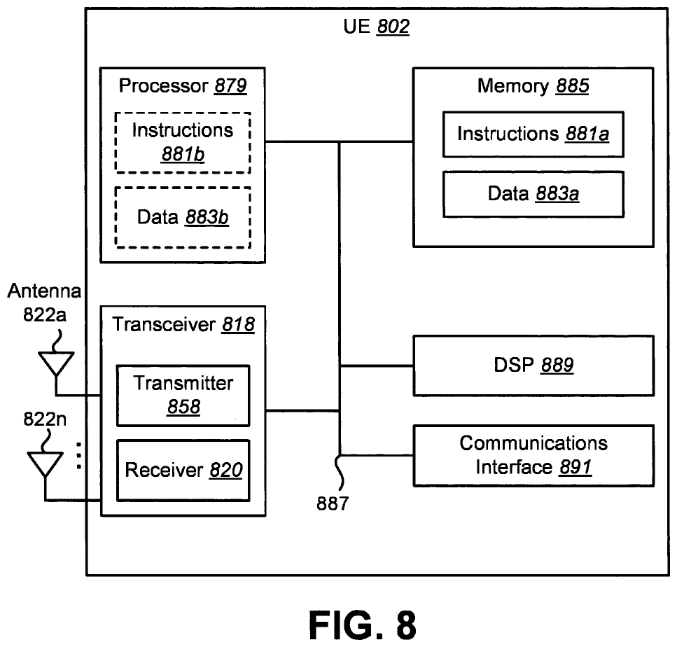

FIG. 8 illustrates various components that may be utilized in a UE 802. The UE 802 (UE 102) described in connection with FIG. 8 may be implemented in accordance with the UE 102 described in connection with FIG. 1. The UE 802 includes a processor 881 that controls operation of the UE 802. The processor 881 may also be referred to as a central processing unit (CPU). Memory 887, which may include read-only memory (ROM), random access memory (RAM), a combination of the two or any type of device that may store information, provides instructions 883a and data 885a to the processor 881. A portion of the memory 887 may also include non-volatile random access memory (NVRAM). Instructions 883b and data 885b may also reside in the processor 881. Instructions 883b and/or data 885b loaded into the processor 881 may also include instructions 883a and/or data 885a from memory 887 that were loaded for execution or processing by the processor 881. The instructions 883b may be executed by the processor 881 to implement one or more of the methods 200 described above.

The UE 802 may also include a housing that contains one or more transmitters 858 and one or more receivers 820 to allow transmission and reception of data. The transmitter(s) 858 and receiver(s) 820 may be combined into one or more transceivers 818. One or more antennas 822a-n are attached to the housing and electrically coupled to the transceiver 818.

The various components of the UE 802 are coupled together by a bus system 889, which may include a power bus, a control signal bus and a status signal bus, in addition to a data bus. However, for the sake of clarity, the various buses are illustrated in FIG. 8 as the bus system 889. The UE 802 may also include a digital signal processor (DSP) 891 for use in processing signals. The UE 802 may also include a communications interface 893 that provides user access to the functions of the UE 802. The UE 802 illustrated in FIG. 8 is a functional block diagram rather than a listing of specific components.

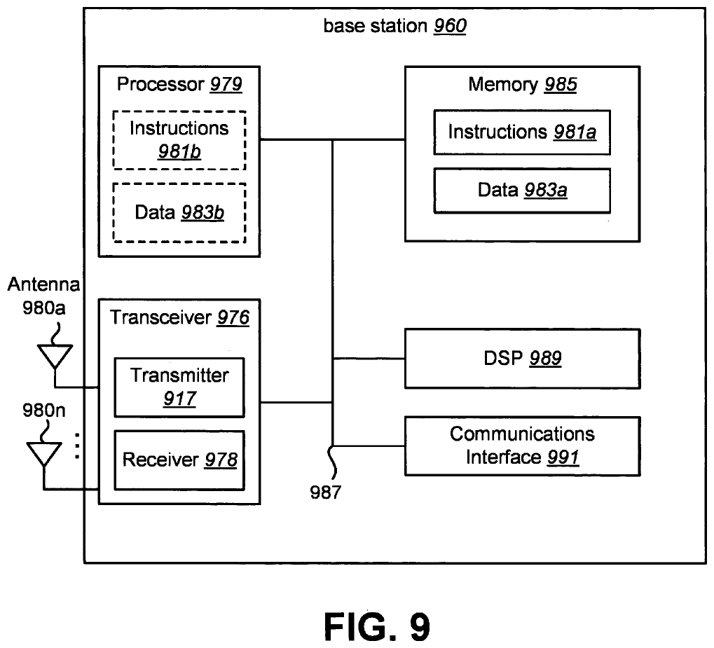

FIG. 9 illustrates various components that may be utilized in a base station 960. The base station 960 described in connection with FIG. 9 may be implemented in accordance with the base station 160 described in connection with FIG. 1. The base station 960 includes a processor 981 that controls operation of the base station 960. The processor 981 may also be referred to as a central processing unit (CPU). Memory 987, which may include read-only memory (ROM), random access memory (RAM), a combination of the two or any type of device that may store information, provides instructions 983a and data 985a to the processor 981. A portion of the memory 987 may also include non-volatile random access memory (NVRAM). Instructions 983b and data 985b may also reside in the processor 981. Instructions 983b and/or data 985b loaded into the processor 981 may also include instructions 983a and/or data 985a from memory 987 that were loaded for execution or processing by the processor 981. The instructions 983b may be executed by the processor 981 to implement one or more of the methods 300 described above.

The base station 960 may also include a housing that contains one or more transmitters 917 and one or more receivers 978 to allow transmission and reception of data. The transmitter(s) 917 and receiver(s) 978 may be combined into one or more transceivers 976. One or more antennas 980a-n are attached to the housing and electrically coupled to the transceiver 976.

The various components of the base station 960 are coupled together by a bus system 989, which may include a power bus, a control signal bus and a status signal bus, in addition to a data bus. However, for the sake of clarity, the various buses are illustrated in FIG. 9 as the bus system 989. The base station 960 may also include a digital signal processor (DSP) 991 for use in processing signals. The base station 960 may also include a communications interface 993 that provides user access to the functions of the base station 960. The base station 960 illustrated in FIG. 9 is a functional block diagram rather than a listing of specific components.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using circuitry, a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods and apparatus described herein without departing from the scope of the claims.

1. A user equipment (UE), comprising:
reception unit configured to receive, from a base station, a cell-specific TDD UL/DL configuration, the cell-specific TDD configuration including a first RRC parameter indicating a first SCS configuration; and
control unit configured to use the first SCS configuration for setting slot format per slot over a number of slots based on the cell-specific TDD UL/DL configuration, each symbol with the used first SCS configuration over the number of slots is indicated as downlink symbol, flexible symbol, or uplink symbol, wherein
time location and frequency location of an UL sub-band is determined respectively by a first information and a second information, the first information at least provides a time offset in unit of symbol with using the first SCS configuration, the second information provides an RB offset and bandwidth with using a second SCS configuration indicated by a second RRC parameter, and
the UL sub-band is configured in symbols indicated as downlink symbol or flexible symbol.

2. The UE according to claim 1 wherein:
the UL sub-band is not configured in symbols indicated as uplink symbol.

3. (canceled)

4. A base station, comprising:
transmission unit configured to transmit, to a user equipment (UE), a cell-specific TDD UL/DL configuration, the cell-specific TDD configuration including a first RRC parameter indicating a first SCS configuration; and
control unit configured to use the first SCS configuration for setting slot format per slot over a number of slots based on the cell-specific TDD UL/DL configuration, each symbol with the used first SCS configuration is indicated as downlink symbol, flexible symbol, or uplink symbol, wherein
time location and frequency location of an UL sub-band is determined respectively by a first information and a second information, the first information at least provides a time offset in unit of symbol with using the first SCS configuration, the second information provides an RB offset and bandwidth with using a second SCS configuration indicated by a second RRC parameter, and the UL sub-band is configured in symbols indicated as downlink symbol or flexible symbols.

5. The base station according to claim 4 wherein:
the UL sub-band is not configured in symbols indicated as uplink symbol.

6. (canceled)

7. A method performed by a user equipment (UE), comprising:
receiving, from a base station, a cell-specific TDD UL/DL configuration, the cell-specific TDD configuration including a first RRC parameter indicating a first SCS configuration; and
using the first SCS configuration for setting slot format per slot over a number of slots based on the cell-specific TDD UL/DL configuration, each symbol with the used first SCS configuration over the number of slots is indicated as downlink symbol, flexible symbol, or uplink symbol, wherein
time location and frequency location of an UL sub-band is determined respectively by a first information and a second information, the first information at least provides a time offset in unit of symbol with using the first SCS configuration, the second information provides an RB offset and bandwidth with using a second SCS configuration indicated by a second RRC parameter, the UL sub-band is configured in symbols indicated as downlink symbol or flexible symbol, and the UL sub-band is not configured in symbols indicated as uplink symbol.
